(19) United States
(12) Patent Application Publication
(10) Pub. No.: US 2020/0055195 A1
(43) Pub. Date: Feb. 20, 2020

(54) Systems and Methods for Remotely Controlling a Robotic Device

(71) Applicant: Taiga Robotics Corp., Toronto (CA)

(72) Inventor: Dmitri Ignakov, Toronto (CA)

(21) Appl. No.: 16/609,947

(22) PCT Filed: May 1, 2018
(86) PCT No.: PCT/CA2018/050511

§ 371 Date: Oct. 31, 2019

Related U.S. Application Data
(60) Provisional application No. 62/500,718, filed on May 3, 2017.

(51) Int. Cl. B25J 13/08; B25J 13/06; B25J 13/00; B25J 3/00; B25J 9/16

(52) U.S. Cl. CPC B25J 13/08; B25J 13/06; B25J 9/1697; B25J 3/00; B25J 13/006

(57) ABSTRACT

A control system for use with a robotic device can include: a) a robot control module having an imaging component configured to capture images of an environment surrounding the robot and an output module that is communicably linked to the robot to control the movement of the its end effector; and b) a user interface apparatus that is remote from the robotic device includes a base station communicably linked to the robot control module to receive images of the environment surrounding the robot from the imaging component and to transmit movement instructions to the output module; a display component communicably linked to the base station and configured to display the images of the environment surrounding the robot to a user; and an end effector controller operable by the user to provide a goal position for the first end effector.

### CROSS REFERENCE TO RELATED APPLICATION

This application claims the benefit of 35 USC 119 based on the priority of co-pending U.S. Provisional Patent Application No. 62/500,718, filed May 3, 2017 and entitled Systems and Methods For Remotely Controlling A Robotic Device, which is incorporated herein in its entirety by reference.

### FIELD

The described embodiments relate to methods and systems for remotely controlling a robotic device.

### BACKGROUND

Remote control of robotic devices can be challenging. The operator at the controller is typically remote from the robotic device being controlled. As a result, the operator will have a limited view of the robotic device and the surroundings of the robotic device.

In addition, the control devices used for controlling the robotic device may not be intuitive for the operator and can require substantial processing at the controller side, which can lead to a slow control system. For example, some robotic control systems operate based on velocity control. The control device controls a velocity of the individual joints of a robotic device to move the joints to the desired position. It can be difficult to achieve precise positioning with velocity control.

### SUMMARY

The various embodiments described herein generally relate to methods (and associated systems configured to implement the methods) for remotely controlling a robotic device.

In accordance with one broad aspect of the teachings described herein, a control system may include a robot control module mountable to a robot having at least a first manipulator with at least a first end effector. The robot control module may include an imaging component configured to capture images of an environment surrounding the robot through which the end effector is movable. The robot control module may include an output module that is communicably linked to the robot to control the movement of the first end effector. A user interface apparatus may be remote from the robotic device and may include a base station communicably linked to the robot control module to receive images of the environment surrounding the robot from the imaging component and to transmit movement instructions to the output module. A display component may be communicably linked to the base station and may be configured to display the images of the environment surrounding the robot to a user. An end effector controller may be operable by the user to provide a goal position for the first end effector. The system may be configured to: a) assign a user synchronization frame to at a first controller position of the end effector controller at a first time, b) assign a robot synchronization frame to the first end effector at a first end effector position, c) track movement of the end effector controller to the goal position at a second time and to assign a hand frame, d) generate a goal transformation based on the relative movement of the end effect controller from the first position to the goal position and the relative positions of the user synchronization frame and the hand frame, and express the goal transformation in the robot synchronization frame to define an end effector goal position, whereby robot control signals are generated and output from the robot control module to move the first end effector from the first robot position to the robot goal position.

The imaging component may be configured to capture 3D images of the environment and the display component is a wearable VR display unit that provides 3D images to the user.

The imaging component may include first and second cameras positioned adjacent each other.

The imaging component may have a field of view and may be movable relative to the robot control module to move the field of view relative to the robot.

The imaging component may be movable independently of the first end effector.

The imaging component may have a field of view and the first end effector may be movable outside the field of view.

The display apparatus may include a display device that is wearable by the user. Movement of the display device may be tracked by the user interface apparatus and imaging command signals may be generated based on the movement of the display device and may be transmitted to the robot control module thereby causing corresponding movement of the imaging component.

The end effector controller may be configurable in a disabled mode in which movements of the effector controller are tracked by the user interface apparatus and the movements of end effector controller are not transferred to the first end effector. Movement of the display device may cause corresponding movement of the imaging component when the first end effector controller is in the disable mode.

The user interface module may be remote from the robotic device.

The user interface module may be in wireless communication with the robot control module.

The end effector controller may be a hand-held apparatus that is movable by the user. Movements of the end effector controller may be translated into corresponding movements of the first end effector.

The position of the end effect controller may be determined independently of a position/configuration of the user's arm.

The robot control signals may be generated using at least one of a force control, a velocity control and an inverse kinematics control scheme.

The first end effector controller may be operable between a disabled mode and an enabled mode. The movement tracked by the first end effector controller during the disabled mode may cause no movement at the first end effector. The base station may receive a disengagement signal from the first end effector controller to trigger the disabled mode and an engagement signal from the first end effector controller to resume the enabled mode.

In accordance with one broad aspect of the teachings described herein, a robotic control system may include a robotic device having a base and a robotic arm mounted to the base. The robotic arm may have at least two degrees of freedom. An end effector may be operably coupled to the robotic arm. An end effector controller may be remote from the robotic device and may be configured to define a goal for the end effector. The goal may include a goal position. A controller processor may be in communication with the robotic device via a communication network and communicatively coupled to the end effector controller. The controller processor may be operable to assign a robot synchronization reference frame to the end effector, assign a user synchronization reference frame to the end effector controller, operate the end effector controller to track a movement defined by an operator, determine the goal based on the tracked movement with respect to at least the user synchronization reference frame, and generate a set of command signals for causing the end effector to move to the goal. The set of command signals may be generated with respect to at least the robot synchronization reference frame.

The goal may include a goal orientation.

The end effector controller may include a handheld component operable by the operator to define the movement. The handheld component may have a hand reference frame. The controller processor may assign the user synchronization reference frame coincident to the hand reference frame.

The end effector may have an end effector reference frame. The controller processor may assign the robot synchronization reference frame coincident to the end effector reference frame.

The controller processor determines the goal based on the tracked movement in response to detecting a trigger event. The trigger event may include at least one of a predefined time interval and the end effector controller being stationary for a defined time period.

The end effector controller may be operable between a disabled mode and an enabled mode. The movement tracked by the end effector controller during the disabled mode may cause no movement at the end effector. The controller processor may receive a disengagement signal from the end effector controller to trigger the disabled mode and an engagement signal from the end effector controller to resume the enabled mode.

The controller processor may assign the robot synchronization reference frame and the user synchronization reference frame in response to receiving the engagement signal.

The robotic device may include an imaging component for collecting imaging data of a surrounding of the robotic device.

In accordance with another broad aspect of the teachings described herein, a robotic control system may include an end effector controller for defining a goal for an end effector of a robotic device. The goal may include a goal position. A controller processor may be in communication with the robotic device via a communication network and may be communicatively coupled to the end effector controller. The controller processor may be operable to: assign a robot synchronization reference frame to the end effector; assign a user synchronization reference frame to the end effector controller; operate the end effector controller to track a movement defined by an operator/user; determine the goal based on the tracked movement with respect to at least the user synchronization reference frame; and generate a set of command signals for causing the end effector to move to the goal. The set of command signals may be generated with respect to at least the robot synchronization reference frame.

The goal may include a goal orientation.

The end effector controller may include a handheld component operable by the user to define the movement. The handheld component may have a hand reference frame. The controller processor may assign the user synchronization reference frame coincident to the hand reference frame.

The end effector may have an end effector reference frame. The controller processor may assign the robot synchronization reference frame coincident to the end effector reference frame.

The controller processor may determine the goal based on the tracked movement in response to detecting a trigger event. The trigger event may include at least one of a predefined time interval and the end effector controller being stationary for a defined time period.

The end effector controller may be operable between a disabled mode and an enabled mode. The movement tracked by the end effector controller during the disabled mode may not cause movement at the end effector. The controller processor may receive a disengagement signal from the end effector controller to trigger the disabled mode and an engagement signal from the end effector controller to resume the enabled mode.

The controller processor may assign the robot synchronization reference frame and the user synchronization reference frame in response to receiving the engagement signal.

In accordance with another broad aspect of the teachings described herein, a method for remotely controlling a robotic device may include operating a controller processor in communication with the robotic device via a communication network and communicatively coupled to an end effector controller to: assign a robot synchronization reference frame to an end effector of the robotic device; assign a user synchronization reference frame to the end effector controller; operate the end effector controller to track a movement defined by a user; determine the goal based on the tracked movement with respect to at least the user synchronization reference frame; and generate a set of command signals for causing the end effector to move to the goal, the set of command signals generated with respect to at least the robot synchronization reference frame.

The goal may include a goal orientation.

The end effector controller may include a handheld component operable by the user to define the movement. The handheld component may have a hand reference frame and the controller processor may be operated to assign the user synchronization reference frame coincident to the hand reference frame.

The end effector may have an end effector reference frame. The controller processor may be operated to assign the robot synchronization reference frame coincident to the end effector reference frame.

The controller processor may be operated to: detect a trigger event; and determine the goal based on the tracked movement in response to the detected trigger event. The trigger event may include at least one of a predefined time interval and the end effector controller being stationary for a defined time period.

The controller processor may receive a disengagement signal from the end effector controller to trigger a disabled mode. The movement tracked by the end effector controller during the disabled mode may cause no movement at the end effector. The controller processor may receive an engagement signal from the end effector controller to resume an enabled mode at the end effector controller.

The controller processor may, in response to receiving the engagement signal, assigns the robot synchronization reference frame and the user synchronization reference frame.

### BRIEF DESCRIPTION OF THE DRAWINGS

Several embodiments will now be described in detail with reference to the drawings, in which:

FIG. 1 is a block diagram representation of one example of a robotic control system;

FIG. 2a is a diagram of a schematic representation of one example of a robotic control system;

FIG. 2b is a diagram of a schematic representation of the robotic control system of FIG. 2a with exemplary reference frames illustrated;

FIG. 3 is a flowchart of an example method of controlling a robotic device;

FIG. 4 is a flowchart of another example method of controlling a robotic device;

FIG. 5a is a perspective view of an example user in accordance with an example embodiment;

FIG. 5b is a side view of FIG. 5a;

FIG. 6a is a side view of an example user at an initial pose in accordance with an example embodiment;

FIG. 6b shows the user of FIG. 6a at a subsequent pose in accordance with an example embodiment;

FIGS. 7a-c are diagrams of example reference frames at the controller;

FIG. 8 is a partial perspective view of the robotic device of FIG. 2a;

FIG. 9 is an enlarged view of a manipulator base joint of the robotic device of FIG. 8;

FIG. 10a is an enlarged view of a wrist and an end effector of the robotic device of FIG. 8;

FIG. 10b shows FIG. 10b annotated with a wrist reference frame and an end effector reference frame in accordance with an example embodiment;

FIG. 11a is a partial side view of the robotic device of FIG. 8 at an initial pose in accordance with an example embodiment;

FIG. 11b shows FIG. 11a annotated with a synchronization reference frame;

FIG. 11c shows the robotic device of FIG. 11a at a subsequent pose in accordance with an example embodiment;

FIGS. 12a-f shows the robotic control system of FIGS. 2a and 2b during operation in accordance with an example embodiment;

FIG. 13a shows the robotic device of FIG. 8 with a goal annotated therein;

FIG. 13b shows FIG. 13a annotated with respect to the manipulator reference frame in accordance with an example embodiment;

FIG. 14a is a top view of FIG. 13b;

FIG. 14b shows FIG. 14a after a first base joint is operated in accordance with an example embodiment;

FIG. 15a is a side view of the robotic arm of FIG. 14b;

FIG. 15b shows the robotic arm of FIG. 15a at a goal in accordance with an example embodiment;

FIG. 15c is a diagram for solving joint angles of the robotic arm of FIG. 15a to reach the goal shown in FIG. 15b;

FIG. 15d is another diagram for solving the joint angles of the robotic arm of FIG. 15a to reach the goal shown in FIG. 15b;

FIG. 16a is a side view of a wrist and an end effector of the robotic device of FIG. 8 at an example pose;

FIG. 16b shows side view of FIG. 16a with the end effector of the robotic device of FIG. 8 at another example pose;

FIGS. 17a-c show the robotic control system of FIGS. 2a and 2b during operation in accordance with an example embodiment;

FIGS. 18a-c show the robotic control system of FIGS. 2a and 2b during operation in accordance with an example embodiment; and

FIG. 19 is a block diagram representation of another example of a robotic control system.

The drawings, described herein, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DETAILED DESCRIPTION OF EXAMPLE EMBODIMENTS

Various apparatuses or processes will be described below to provide an example of an embodiment of each claimed invention. No embodiment described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim or dedicate to the public any such invention by its disclosure in this document.

The various embodiments described herein generally relate to systems and methods for remotely controlling a robotic device and specifically, an end effector mounted to the robotic device. The end effector can be coupled to a base portion of the robotic device by any suitable type of manipulator, such as, for example, by a robotic arm having one or more degrees of freedom, such as a multi-segment/portion articulated robotic arm, having a variety of joints between portions and each joint having a desired range of motion/degree of freedom (i.e. each joint within the arm may have 1, 2, 3 or more degrees of freedom). The robotic device may be configured so that the manipulator has a first end that is connected to the base, extends generally away from the first end and terminate at a second end that includes the end effector. In this configuration, the end effector is movable relative to the first end of the manipulator and relative to the base portion. Optionally, in such arrangements, the robotic device may be configured so that there are at least two degrees of freedom between the base portion and/or first end of the manipulator and the end effector.

Some of the methods and systems operate on a position-based control scheme, where the joints in the robotic device can be commanded/driven to apply a specific torque/velocity. Such systems may help provide greater accuracy in the control of the end effector, as compared to some known systems.

An end effector controller may be manipulated by a system user (e.g. a human) and used to help control the end effector on the robotic device. A controller processor may track a position and/or pose of the end effector controller, and optionally may track the position continuously and/or in real time from a user's perspective (i.e. at a sampling rate that is sufficiently fast such that a system user does not perceive a lag between controller input and robotic device movement).

Optionally, the robot device may be positionable in, and moveable between a variety of poses. A pose, as discussed herein, may include a position of the end effector and optionally an orientation of the end effector, and similarly the position and/or orientation of the associated end effector controller that is being manipulated by the user. For example, in some embodiments, it may be desirable for the orientation of the end effector (relative to the robotic device) to remain generally fixed and/or static. In such configurations, a user's inputs, e.g. via a suitable end effector controller, may be transformed into movements of the end effector through space while the orientation of the end effector remains generally constant. For example, the end effector may be a tray for carrying objects that is configured to remain in a generally upright configuration (to avoid spilling objects off the tray) while the position of the end effector is changed (i.e. to bring the tray closer to or farther from a desired location).

Optionally, during operation of the robotic control system, the controller processor may cause the end effector to move toward a goal, which may correspond to a position and/or pose tracked by the end effector controller. Based on the goal indicated by the end effector controller, the controller processor may determine appropriate command signals for driving the robotic arm toward the goal. The response rate of the end effector can optionally be variable, and need not match the inputs of the end effector controller. For example, the response rate of the end effector may vary with, at least, the processing and data transmission rate at the controller and the robotic device, and the speed at which the robotic arm can be operated.

In some embodiments, the controller processor can generally continuously transmit command signals to the robotic device so that the end effector is generally continuously moved to the position and/or pose indicated by the end effector controller. In such embodiments, a command signal may be considered to be continuous if it allows the robotic device to respond in what appears to be a generally smooth, continuous manner to a user, as compared to a step-by-step or stuttering motion. In some systems, such continuous behavior may be achieved by operating the controller system at a sampling rate/frequency that is generally “fast enough” to appear continuous to a human user. For example, the system may operate with a sampling frequency of about 100 Hz, or more, may allow the system to operate in a manner that is generally sufficient for it to appear substantially “continuous” to the user. In this arrangement, the movement of the robotic device may effectively match the inputs from a user in real time, and the end effector may appear to mirror/shadow the movements of the end effector controller. This may help provide a natural feeling experience to the user, in which the user may feel the end effector behave in a manner that is consistent with the movement of the user's natural hand.

Alternatively, instead of mirroring or tracking the user's input movements in real time, the system may be configured so that the controller processor transmits command signals to the robotic device at a notably slower refresh rate or time intervals (i.e. once per second, once per 10 seconds, etc.) and/or in response to one or more predetermined trigger events. The trigger events may be any type of condition that can be monitored by the system, including, for example, when the end effector controller is stationary for a defined period of time (such that the system believes the user has “finished” a given movement) and/or when the end effector controller enters a disabled mode. Operating the robotic device in this manner may help reduce power consumption and/or may help reduce unnecessary movements for the robotic device. For example, a user may wish the end effector to move directly from a starting position to a desired end position, without necessarily tracing the entire movement path that the user performed when moving the end effector controller. Optionally, the system may be configured such that it can be switched between these, and optionally other operating modes, based on user input, task recognition, limitations of the controller processor power, limitations in the robotic arm configuration and other such criteria.

Optionally, the command signals for driving a given robotic device based on the user inputs via the end effector controller may be determined based on any suitable translation protocol. For example, the command signals can be determined with respect to respective synchronization reference frames that can be assigned to coincide with the end effector and the end effector controller during operation of the robotic control system. Such synchronization reference frames can optionally act as offset reference frames, that can be used to help determine the relative location of the end effector controller and/or end effector and to help determine the nature of the movement required from the robotic device for the end effector to track the inputs from the end effector controller in a desired manner. Different translation protocols can be provided for different robotic devices (e.g. having different numbers of joints, ranges or motion, degrees of freedom, etc.) such that a given end effector controller may be configured for use with two or more different robotic devices, having different properties. This may help facilitate the customization of the system for a given application.

For example, a user synchronization reference frame may be assigned, by the system, to capture information (such as position information in 3D x,y,z, co-ordinates and/or orientation and/or rotation information) for a current pose of the end effector controller at a first time, and an analogous robot synchronization reference frame can be assigned at a current pose of the end effector. The relative movement of the end effector controller can then be tracked relative to its corresponding user synchronization reference frame, and the corresponding movement of the end effector can then be executed by determining the movement of the end effector that is required so that the relation between the end effector reference frame and the robot synchronization reference frame will correspond to the relation between the end effector controller reference frame and the user synchronization reference frame.

Preferably, the pose of the end effect controller can be tracked independently of the rest of the user's arm and body. For example, in preferred embodiments the system need not track the position, or change in position, of a user's wrist, elbow, shoulder, torso or the like in order to determine the relative movement of the end effector controller and/or to determine the movements required by the robotic device. Similarly, the user need only consider the position of the robotic end effector and its desired movement, rather than also considering the position and/or orientation of each intervening part of the robotic device between the base portion and the end effector.

Because the system can be configured to control the robotic device based on the desired position/movement of the end effector, as opposed to requiring a user to control the intervening robotic arm portions and joints, the behavior of the robotic device may feel somewhat more natural and/or intuitive to a human user, who is used to navigating a 3D world by directing the position of his/her hands—as opposed to separately thinking about a desirable position and/or orientation for his/her shoulder, upper arm, elbow, lower arm, wrist and hand. The system and methods described herein may help facilitate control of a robotic device in a seemingly natural, intuitive manner by helping to allow the movements of the end effector controller (held by a user's hand in the examples described herein) to be translated to corresponding movements of the robotic end effector without requiring separate information regarding the position of the user's arm, shoulder and wrist, and without a user having to actively consider the position of the individual robotic device segments/portions and joints.

Optionally, this control system may be further enhanced by providing visual feedback to the user to help him/her feel as if he/she is in the position of the robotic device and is directly interacting with its surrounding environment. One way to help facilitate this additional degree of integration is to provide an imaging component that can capture and transmit information about the environment surrounding the robotic device. The information captured by the imaging component may then be processed (optionally) and displayed to the user. The information may be displayed to the user using any suitable user display device, including a display screen(s), a wearable display device such as a virtual reality display headset (VR display) and the like. The display for the user can be a two-dimensional display, but preferably is configured to be a three-dimensional (3D) display that can help provide the user with depth-perception and increase the user's feeling of immersion in the system. Preferably, the display can help a user feel as if he/she is located in the environment of the robotic device and can interact with that environment in a generally natural, intuitive manner. Optionally, the information relating to the environment surrounding the robotic device can be captured as visual information (e.g. photos and/or video) captured using optical sensors, but alternatively may be captured using distance/proximity sensors, thermal sensors, RADAR, LIDAR, SONAR and other suitable techniques. The display provided to the user may be in the same form as the captured information, e.g. video captured by the imaging component may be displayed as video to the user. Alternatively, the system may process the environmental information prior to displaying it to the user. For example, the imaging component may capture distance-based information using a LIDAR sensor and the system may then generate a 3D computer model based on the data that can be visually presented to the user on a display screen or via a VR headset.

Optionally, at least some of the imaging components, such as the sensors/transducers, may be mounted to the robotic device that is being controller, or alternatively may be remote from the robotic device and mounted on other suitable objects. For example, one or more cameras may be positioned in the environment surrounding the robotic device, optionally statically, and the display provided to the user may be based on the inputs from the one or more cameras. In another example, sensors and/or cameras may be mounted to a different robotic device, a vehicle, a human, an animal or other movable object that is in proximity to the robotic device. For example, imaging and distance-based sensors may be provided on an aircraft, drone or the like that is flying above the environment in which the robotic device is operating. Data from such sensors can then be processed to provide a 3D display, such as computer-generated 3D model, to the user that represents the robotic device's point of view in the environment.

Optionally, the robotic device may be movable through its environment, and preferably may be at least partially self-propelled. This may help move the robotic device on a relatively macro scale, which may help bring the manipulator into the general proximity of an object to be manipulated and/or inspected. For example, the base of the robotic device may include any suitable type of locomotion apparatus that is configured to move the robotic device through its environment. This may include wheels, tracks, treads, legs and the like for moving the robotic device across the ground (which is understood to include floors, roads and other man-made surfaces, as well as natural surfaces), and may also include wings, rotors, jets and the like for moving the robotic device through the air and optionally may include propellers, thrusters, elevators and the like for propelling the robotic device on or under water or other liquids. For example, the base of a robotic device may include wheels that are used to drive the robotic device around its environment and can be used to move the robotic device into a position where a specific object or area of interest is within the range of motion of its end effector/manipulator. The movement of the robotic device may be generally self-propelled and may be controlled by a user, or may be at least partially autonomous.

Optionally, in addition to one or more locomotion apparatuses, the robotic device may also include other devices/apparatus for changing the configuration of the robotic device and moving its manipulator into a desired position. For example, a robotic device may include one or more lifting apparatus that can be operated to raise and lower portions of the base to different elevations. If the manipulator is mounted to the movable portion of the base, it may also be raised and lowered to different elevations, which may help facilitate the manipulator being able to reach or interact with different elevations in the environment. For example, the robotic device may include a work platform that may be raised and lowered relative to a lower base portion. If the manipulator is mounted to the movable platform, it may also be raised and lowered. In such a configuration, the platform may be raised to an elevated height, such as proximate a ceiling, and the manipulator may then be used in an elevated position, such as to grip or inspect and object on the ceiling that would have been outside the reach of the manipulator from the lowered position. The work platform may be configured to hold one or more people and raise them to an elevated working position along with the manipulator. Optionally, the person controlling the manipulator may be on the work platform or may be in a remote location.

A robotic device may include both a locomotion apparatus and a lifting apparatus, or the like. For example, the device may include wheels or tracks for moving the base portion laterally, as well as a lifting apparatus for elevating a movable base portion.

Optionally, the manipulator itself may be capable of changing its size/configuration, as the manipulator may include one or more extensible or telescoping sections such that the maximum distance between its first end and its end effector can be varied.

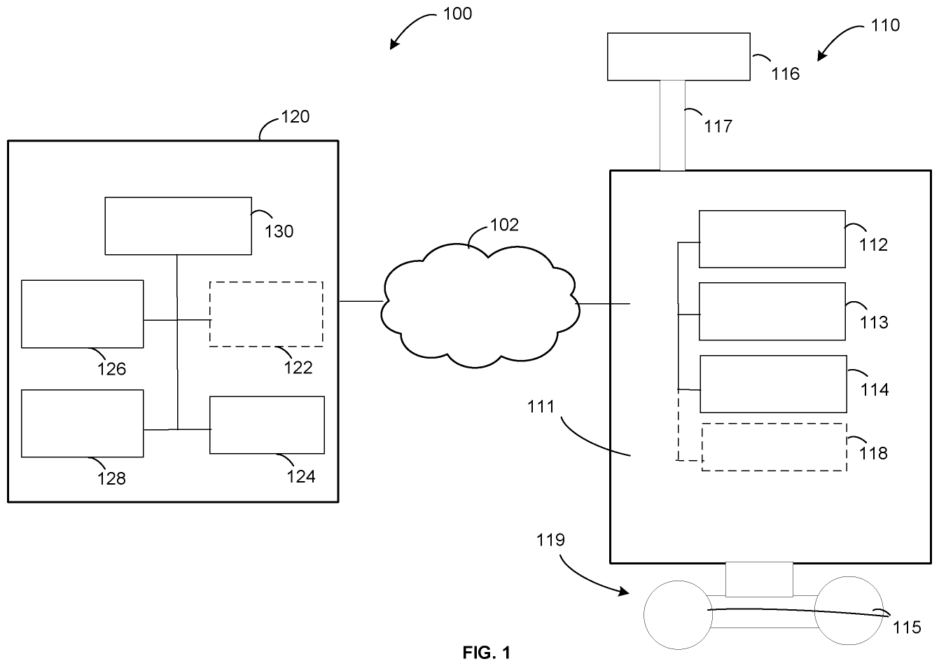

FIG. 1 is a schematic representation of one example robotic control system 100. The robotic control system 100 includes a user interface apparatus 120, a robotic device 110, and a network 102 over which data signals are sent between the user interface apparatus 120 and the robotic device 110. It will be understood that although only one robotic device 110 is shown in FIG. 1, more than one robotic device 110 can be provided within the robotic control system 100 and controlled by the user interface apparatus 120.

The network 102 may be any network capable of carrying data, including the Internet, ethernet, coaxial cable, fiber optics, satellite, mobile, wireless (e.g. Wi-Fi, WiMAX), SS7 signaling network, fixed line, local area network, wide area network, cellular networks and others, including any combination of these, capable of interfacing with, and enabling communication between the user interface apparatus 120 and the robotic device 110. For example, the network 102 can be implemented over an Internet Protocol (IP) network that uses the Transmission Control Protocol (TCP) and the User Datagram Protocol (UDP). The network 102 may also include a wireless link dedicated for transmitting command signals for causing a stop motion.

In some embodiments, the network 102 can include two or more networks for transmitting different data. For example, command signals for operating the robotic device 110 can be transmitted via a first network that is optionally more robust (to help ensure control of the robotic device 110 is maintained) while imaging and/or video data can be transmitted via a second network that may be less reliable under some operating conditions but enables a high throughput. In the event that communication between the robotic device 110 and the user interface apparatus 120 is interrupted, the robotic device 110 may be configured to pursue one or more predetermined courses of action, including, for example, freezing and remaining in the position it was in when communication was lost, automatically returning to a pre-determined “home” position and the like.

In this example, the user interface apparatus 120 includes an end effector controller 124, a controller interface component 126, a controller storage component 128 and a controller processor 130. The end effector controller 124, the controller interface component 126, the controller storage component 128 and the controller processor 130 can communicate with each other. By manipulating the end effector controller 124 a user may be able to control the movement of an end effector of an associated robotic device, including using the methods and systems described herein.

Optionally, the user interface module 120 may include a display component 122 that can display images and other information to the user who is operating the system 100, and that can communicate with the other components in the user interface apparatus 120. This may help provide visual information to a user in instances where the robotic device 110 is out of the user's line of sight or the regions in which the end effector of the robotic device 110 can be operated may be otherwise obscured from the user. In other embodiments of the system 100, the user interface apparatus 120 may include other modules and/or components and need not include a display component in all embodiments. For example, a display component may not be required in instances where the user can maintain a direct line-of-sight to the robotic device, and/or if the user is positioned on or in the robotic device itself. Users positioned on or in the robotic device, such as a device that is configured as an exo-skeleton or that includes arms or other such manipulators mounted to a vehicle or work platform that is carrying the user, may already have a “first person” view of the manipulator(s) and may not require or desire a separate user display component.

Optionally, as shown in the illustrated example, the user may be expected to be remote from the robotic device and the display component 122 may provide the user of the end effector controller 124 with a view of the environment surrounding the robotic device 110. This may help provide the user with visual information about the environment surrounding the robotic device 110, which may help the user navigate the robotic device and/or provide other contextual information that a user may utilize when using the system 100. For example, the display component 122 may provide the user with a 3D and/or virtual reality-type perspective of the environment, so that the operator can effectively view the environment from the perspective of the robotic device. This type of “first person” perspective may help give the operator a sense of being in the position of the robotic device 110, which may help make the use of the robotic device 110 feel more intuitive to the operator (as opposed to observing the environment from a remote, third-person perspective).

The view available at the display component 122 may vary depending on whether an imaging component is available for the robotic device 110 and where the imaging component is mounted relative to the robotic device 110. When an imaging component is not available, the view shown at the display component 122 can be an image of the environment surrounding of the robotic device 110 taken, for example, by a remote camera or other device. When an imaging component is provided remote from the robotic device 110, the view shown at the display component 122 may be in real-time and/or controlled by the operator or a third-party cooperating with the operator of the end effector controller 124.

Optionally, the image provided to the operator may change as the system 100 is in use. For example, the system 100 may update the image provided based on one or more input criteria, such as the orientation of the operator's head and/or changes in the orientation and/or position of the robotic device 110. Preferably, the system 100 can be configured to track the position of the user's head and the direction he/she is looking. These movements can then be transferred to the imaging component 118 and can be used to control the position of the imaging component 118, and its associated field of view, accordingly. Alternatively, when imaging in 3D with a LIDAR or a 3D camera, the field of view presented to the user can be adjusted virtually, such that the field of view of the user appears to be synchronized, but the imaging component may not need to be physically moved. This may help provide substantially the same effect, i.e. to provide a useful and generally immersive view of the environment around the robotic system.

For example, if a user turns her head to the left, the imaging component 118 can also be adjusted so that its field of view moves “to the left” from the user's perspective. Substantially syncing the field of view of the imaging component 118 and the user's head position/orientation can help provide an immersive experience to a user and can help the system provide a generally useful view to the user, without requiring the user to separately, consciously control the field of view of the imaging component 118. Preferably, the field of view (and other attributes of the imaging component 118) can be manipulated independently of the end effector controller 124 (and end effector on the robotic device).

Optionally, the nature of the image displayed to the operator may be based on the position or movement of the end effector controller 124, such that moving the end effect effector controller updates both the image provided to the operator and the physical location of the end effector. Alternatively, the system 100 may be configured so that the nature of the image displayed to the operator can be selected independently from the physical location of the end effector. For example, the end effector 116 may be moved from point A to point B that are both within the existing field of view/image displayed to the operator. Under such conditions, it may not be necessary to change the image displayed to the operator as she can still readily observe the current position of the end effector. Similarly, if the end effector 116 momentarily travels to a location outside the current field of view of the operator, but then returns to the field of view it may not be necessary to modify the field of view. Alternatively, if movement of the end effector 116 takes it out of a given field of view provided to the operator when it reaches its final position, it may be desirable to update the field of view to show the current position of the end effector when movement is complete (optionally without updating the field of view to reflect each, transient intervening position of the end effector 116).

For example, when the imaging component 118 is mounted at the robotic device 110, the view shown at the display component 122 may optionally be controlled by the operator (or a third party) independently from the operation of the end effector 116. That is, it is possible that the imaging component 118 faces a different direction than a direction of the end effector 116.

Optionally, the user interface apparatus 120 can include a mechanism for tracking the head position of the system operator, such that the image displayed to the user can be based on the direction the operator is looking. That is, in systems where the image provided to the operator is a real-time 3D image of the environment surrounding the robotic device, the system 100 may be operable to detect that a user has turned her head to the left (e.g. to look for an object or target in the environment around the robotic device) and may then update the image provided to correspond to the environment on the left side of the robotic device. This may help an operator feel intuitively connected to the robotic device and/or feel immersed in the environment surrounding the robotic device 110 (as opposed to the physical environment surrounding the operator).

For example, the display component 122 can include a head-mounted control system, such as a virtual reality headset, that can remotely control the orientation/perspective of the imaging component 118 in response to the user's head movements while also receiving and displaying the imaging data received from the imaging component 118. The head-mounted control system can include orientation sensors, such as a gyroscope, or position sensors, such as an accelerometer, for detecting and tracking the movement of the operator's head. In some embodiments, the display component 122 can include a screen capable of displaying three-dimensional (3D) images or an immersive virtual reality environment, such as the Cave Automatic Virtual Environment (CAVE).

Optionally, the display component 122 may be configured to display the image generated from data collected by the imaging component 118 with a relatively small degree of latency. Reducing the latency in displaying the view of the imaging component 118 may help improve the operator's experience and/or the sense of immersion in the system.

In the illustrated example, the end effector controller 124 is operated by the operator to define a position or a pose of the end effector 116. Preferably, the end effector controller 124 is configured as handheld device that can be grasped and manipulated by a human user. Preferably, the end effector controller 124 is wireless or is communicably linked to other aspects of the system (such as a base station as described herein) using a flexible wire or the like such that a user can generally freely manipulate the end effector controller 124 though a natural human range of motion without having his/her movements restricted by physical connections between the end effector controller 124 and other system components. This may help enhance the user's experience and sense of immersion within the system.

The end effector controller 124 may include any suitable sensors and the like to gather the desired position and orientation information, including, for example a motion detector, accelerometer and the like for detecting an orientation of an operator's hand and for tracking the position of the operator's hand.

Preferably, the end effector controller 124 can operate at a relatively high data rate.

The motion detector can be held or worn by the operator, can be a mechanical motion tracker that detects motion and/or force exerted by an operator and optionally can provide feedback, and optionally physical feedback, to the operator (e.g., haptic devices), or can be located proximal to the operator to track a hand-held object. The object can be a high-contrast object held by the operator. For example, the high contrast markers can include infrared (IR) reflective markers or LEDs, or a glowing coloured ball.

The end effector controller 124 can be a controller such as a magnetic beacon controller (such as a Razer Hydra™ motion and orientation detector developed by Sixense Entertainment) or an image or IR based motion tracker. With the magnetic beacon controller, a base unit emits a specific fluctuating magnetic field. The controller returns the position and orientation of a hand piece based on measurements of the magnetic field detected at the hand piece.

Example end effector controllers 124 include Oculus Touch™, HTC Vive™, Sixense™, Wii™ motion controller, a wearable glove, Sony™ motion controller, Leap Motion™ or Kinect™. It will be understood that these example end effector controllers 124 are listed only for exemplary purposes and do not limit the end effector controllers 124 that can be used in the robotic control system 100.

The end effector controller 124 can communicate with the controller processor 130 and the controller interface component 126 via a wired connection (e.g. ethernet, stereo mini-plug, serial port, USB connection, etc.) or wirelessly, such as via Bluetooth, Bluetooth Low Energy (BLE), or wireless LAN (IEEE 802.11x) or other wireless protocols.

The controller interface component 126 acts as a base station component and can operate as a communication interface between the user interface apparatus 120 and the network 102, and as a communication interface between the controller processor 130, the display component 122, the end effector controller 124 and an optional controller storage component 128. The controller interface component 126 can include any suitable hardware components, including an on-board power supply, user display apparatuses/features (lights, screens, speakers, etc.) and communications apparatuses can include at least one of a serial port, a parallel port or a USB port, and/or at least one of a Local Area Network (LAN), Ethernet, Firewire, modem or digital subscriber line connection.

The controller storage component 128 can include one or more data storage systems (including volatile memory or non-volatile memory or other data storage elements, or a combination thereof). The controller storage component 128 can store command signals generated by the controller processor 130 and/or data related to the operation of the user interface apparatus 120 and the robotic device 110. For example, the synchronization frames can be stored at the controller storage component 128, in the robotic device 110, in a separate remote storage unit or any combination thereof.

The controller processor 130 may be any suitable processors or digital signal processors that can provide sufficient processing power depending on the configuration, purposes and requirements of the user interface apparatus 120. The controller processor 130 can initiate the robotic device 110 via the network 102. The controller processor 130 can trigger the transmission of command signals to the robotic device 110 via the controller interface component 126. The controller processor 130 can also trigger the display component 122 to show images generated from imaging data collected by the imaging component 118.

The controller processor 130 can include one or more controller processors. For example, one controller processor determines and generates command signals for operating the end effector 116, whereas another controller processor processes imaging data. The distribution of the processing of the imaging data and the processing of the command signals to different controller processors can increase the robustness of the robotic control system 100 as the image processing pipeline does not interfere with command signal generation. This may also help make the system more scalable as more processors can be added to do any new tasks or as computational demands increase.

Referring still to FIG. 1, in this example the schematic representation of a robotic device 110 includes a device processor 112, a device storage component 113, a device interface component 114, a base 111, a manipulator 117 that is movable relative to the base 111 and that includes at least one an end effector 116 mounted thereon, and a locomotion apparatus 119 that can allow the base 111 to move across a surface. In the illustrated example, the locomotion apparatus 119 includes wheels 115 and a suitable drive apparatus (e.g. an electric motor or the like), but in other examples may include treads, legs, skis or the like. As described herein, the robotic device 110 can optionally include an imaging component 118. Optionally, at least some of a device processor 112, a device storage component 113, a device interface component 114 can be provided in a generally self-contained robot control module that is provided in combination with the user interface apparatus 120 and can be mounted to the robotic device 110 to communicate with the manipulator 117 and end effector 116.

The device processor 112 may be any suitable processors or digital signal processors that can provide sufficient processing power depending on the configuration, purposes and requirements of the robotic device 110. Optionally, the device processor 112 may include a control loop feedback mechanism, such as a proportional-integral-derivative (PID) controller. The device processor 112 can operate each of the device storage component 113, the device interface component 114, the end effector 116 and the imaging component 118 based on the command signals received from the user interface apparatus 120. For example, the device processor 112 can operate the end effector 116 to manipulate an object based on command signals received from the user interface apparatus 120. The device processor 112 can also orient the imaging component 118 in different directions based on command signals received from the user interface apparatus 120.

Similar to the controller processor 130, the device processor 112 can include one or more device processors. For example, one device processor receives and interprets command signals for operating the end effector 116, whereas another device processor collects and transmits imaging data. The distribution of the processing can help increase the overall robustness and/or scalability of the robotic control system 100.

The device storage component 113 can include one or more data storage systems (including volatile memory or non-volatile memory or other data storage elements, or a combination thereof). The device storage component 113 can store command signals received from the user interface apparatus 120 and/or data related to the operation of the user interface apparatus 120 and the robotic device 110. For example, the synchronization frames can be stored at the device storage component 113.

The device interface component 114 acts as a communication interface between the robotic device 110 and the network 102, and optionally as a communication interface between the device processor 112, the device storage component 113, the end effector 116 and the imaging component 118. The device interface component 114 can include at least one of a serial port, a parallel port or a USB port, and/or at least one of a Local Area Network (LAN) and Ethernet.

The manipulator 117 may be any suitable type of apparatus, including an articulated robot arm and the like. It may have any suitable degrees of freedom, and preferably will have at least two degrees of freedom.

The end effector 116 is operated by the device processor 112, or optionally by the controller processor 130 or other suitable processor or combination thereof, according to the command signals received from the user interface apparatus 120. Different end effectors 116 can be mounted on a given robotic device 110 for manipulating objects and/or detecting a surrounding of the robotic device 110. For example, the end effector 116 can be a clamp or a set of jaws for manipulating an object. In some embodiments, a force sensor can be coupled to the end effector 116 for detecting an amount of force exerted by the clamp on the object. Other examples of end effectors 116 can include, but are not limited to, anthropomorphic hand manipulators, different types of grippers, a holder for tools (e.g., a mount for a drill), and a tool that can operate as a paint roller, drill, wrench, welding equipment, saw, torch, lifting forks or shackles, etc.

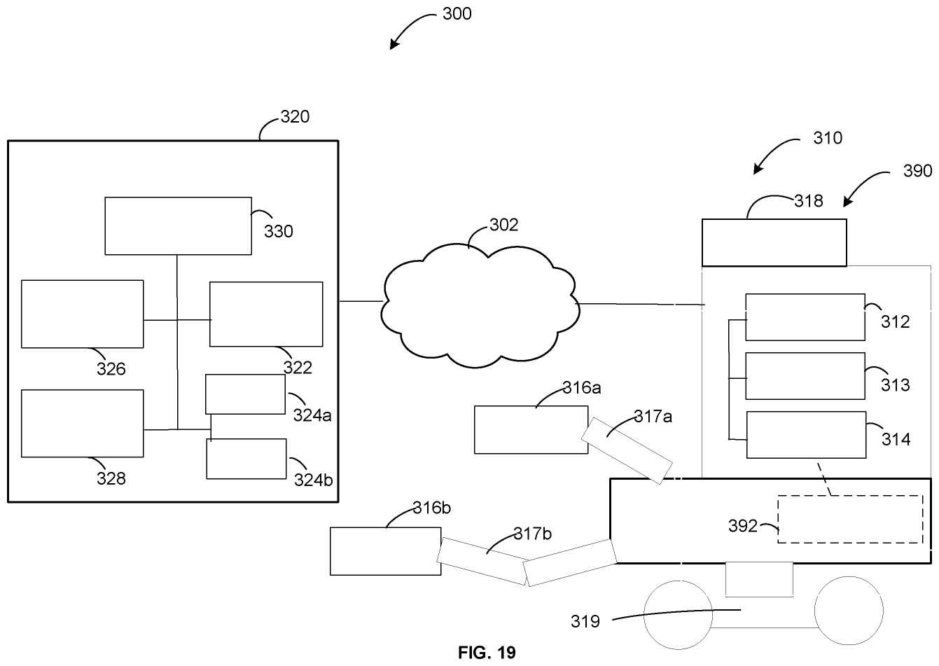

In some embodiments, two or more end effectors 116 can be mounted to the robotic device 110 with respective robotic arms or other suitable manipulators (see FIG. 19).

Optionally, an imaging component 118 can also be mounted to the robotic device 110. Preferably, the imaging component 118 can be mounted so that it is movable relative to the base 111, or so that its field of vision is movable relative to the base 111. This may include mounting the imaging component 118 on a rotatable base, and articulated arm, another suitable manipulator, on the manipulator 117, on the end effector 116 or other suitable locations. If the imaging component 118 is moveable, it may be movable independently of the end effector 116. That is, the orientation of the imaging component 118 can preferably be adjusted relative to the end effector 116 during the operation of the robotic device 110 (but alternatively may be fixed relative to the base 111). The imaging data collected by the imaging component 118 can be transmitted to the user interface apparatus 120 for processing by the controller processor 130 and display by the display component 122, or alternatively, the imaging data can be processed by the device processor 112 and the device interface component 114 can then transmit the processed imaging data to the user interface apparatus 120.

When the imaging component 118 is mounted to the robotic device 110, the display component 122 may provide a relatively real-time view of the surrounding area of the robotic device 110. The operator can also benefit from an immersive experience when 3D images are shown at the display component 122 due to the depth perception offered by the 3D images.

In some embodiments, the imaging component 118 collects imaging data to generate 3D images of the surrounding within a field of view of the imaging component 118. For example, the imaging component 118 can include a pair of imaging devices, such as cameras, for collecting data to generate a stereoscopic image. In some embodiments, the imaging component 118 can include a device for conducting Light Detection and Ranging (LIDAR).

In some embodiments, the imaging component 118 may not be needed. For example, the operator controlling the end effector controller 124 may have an unobstructed view of the robotic device 110 and its surroundings. In some other embodiments, the imaging component 118 can be remote from the robotic device 110, such as a drone.

In use, the robotic device 110 is operable remotely by the user interface apparatus 120 via the network 102. For example, the device interface component 114 receives command signals from the user interface apparatus 120 via the network 102 and the device processor 112 processes the command signals for positioning the end effector 116 and/or the imaging component 118 according to the command signals. The user interface apparatus 120 can transmit command signals for operating the imaging component 118 separately from the command signals for operating the end effector 116.

The robotic device 110 can also transmit data signals to the user interface apparatus 120 via the network 102. For example, the controller interface component 126 can receive data signals from the robotic device 110 related to feedback at the end effector 116. These data signals may include visual information from the imaging component 118 as well as feedback from other optional sensors provided on the robotic device 110 (temperature, pressure, velocity, humidity and the like) as well as feedback related to the movement and operation of the manipulator 117 and end effector 116 (including, for example force feedback). The end effector controller 124, for example, may also include a haptic device feedback transducer operable to receive haptic feedback based on the operation of the end effector 116 and provide corresponding physical feedback to the user. The controller interface component 126 can also receive imaging data obtained by the imaging component 118 and show a resulting image via the display component 122.

Optionally, to help prevent the manipulator and/or end effector from entering singular regions and to help reduce the chances collisions with the ground or other objects the goal position of the end effector can be restricted to a pre-defined “safe region” of space surrounding the robotic device that is free from obstacles and the like. If the user inputs a goal position for the end effector 116 that is outside the pre-determined safe region the system 100 can instead replace the user's target location with a modified target location that is the location within the safe region that is closest to the user-selected goal location.

One example of a method of operating a robotic control system, such as the examples of systems described herein, is described below. In this example, a Controller frame C is considered to be the reference frame with respect to which the pose of the end effector controller is referenced, and may be based on the location of the controller interface component 126. A frame H can be attached rigidly to the end effector controller 124. A robot frame R can be provided somewhere on the robotic device. The robot frame R may be considered to be analogous to the frame C in the sense that it is a basic reference frame, with respect to which the goal or target of the end effector 116 can be calculated, for example via inverse kinematics or any other suitable process as described herein.

The method may include a first step in which the system is in in a disabled state whereby movement of the end effector controller is not conveyed to the robotic device. In this state the user is able to move his/her hand and the end effector will not move.

While in the disabled state the system can continue to track the position of the end effector controller but does not actually transmit movement instructions to the robotic device. That is, the system may listen for input from the user (continuously and/or at a predetermined sampling frequency), and may get updates on the pose of the end effector controller while the system is in both the enabled and disabled states. This can be defined as T_{C,H}, which is the transformation between the H frame attached to the end effector controller, and the C frame.

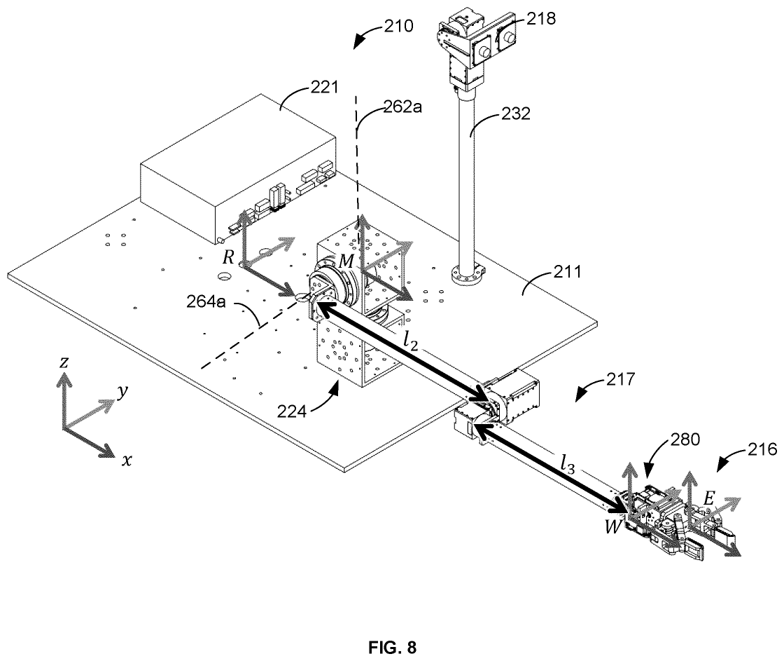

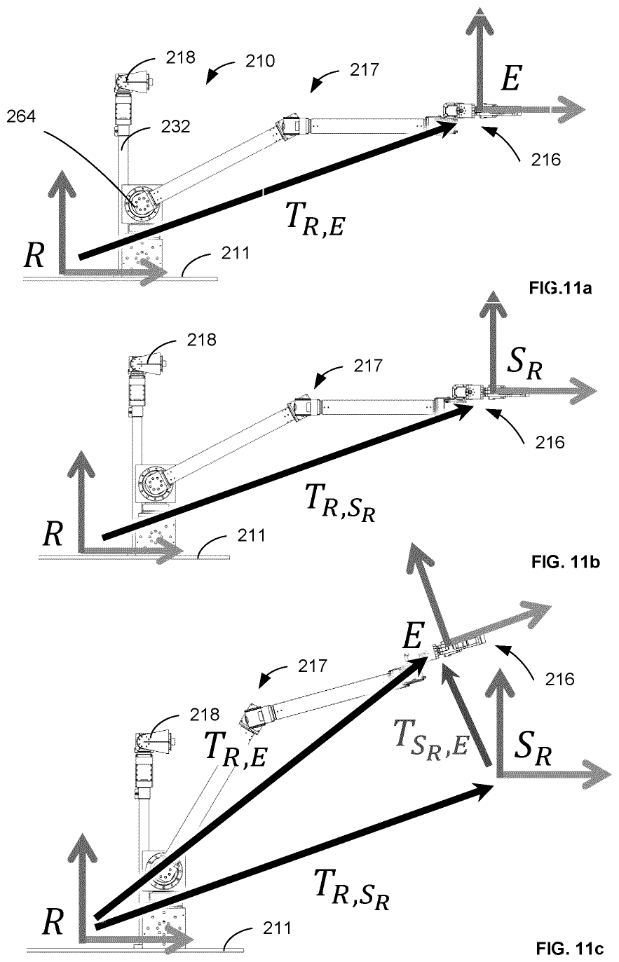

When the system changes from its disabled state to an active or enabled state the system may take a number of actions, such as:
i) the user synchronization frame S_{U} may be set to coincide with the current H frame. This transformation (T_{C,S}_{_{U}}) may be recorded for future use: T_{C,S}_{_{U}}=T_{C,H}; and
ii) The robot synchronization frame S_{R} may be set to coincide with the current end effector frame E (see FIG. 8). This transformation (T_{R,S}_{_{R}}) may be recorded for future use: T_{R,S}_{_{R}}=T_{R,E} (FIGS. 11a and 11b)

These reference frames are used to help ensure that the end effector moves in the same manner as the end effector controller, and to allow the user to stop, move and reposition themselves while the system is in the disabled state without causing corresponding movements of the end effector, and then to re-enable the system and resume control of the end effector from where they left off.

When the system transitions from its disabled state to its enable state (i.e. when user control is started), the frames C and H may be synchronized. At that time, he user's hand pose can be calculated with respect to the user synchronization frame S_{U}, and the robotic device will try to position its end effector at the corresponding (and optionally scaled) pose with respect to the robot synchronization frame S_{R}.

While the system is in the enabled state it can update the end effector controller pose: T_{C,H} at a given sampling rate. The sampling rate may be pre-determined and may remain constant while the system is enabled. Alternatively, the sampling rate may be dynamic, and may change while the system is in use.

To synchronize the user's command and the end effector actions the system can calculate what the pose of the end effector controller is with respect to the user synchronization frame S_{U} at a given time:

T_{S}_{_{U}}_{,H}=T_{C,S}_{_{U}}⁻¹T_{C,H}

where T_{C,S}_{_{U}} was recorded in steps noted above.

Optionally, the rotation component of T_{S}_{_{U}}_{,H} can be set to:

rot(T_{S}_{_{U}}_{,H})=rot(T_{C,H})

This may help facilitate the target rotation, before scaling, to be aligned with a constant reference frame, and may help ensure the robot's end effector 116 matches the user's hand in a relatively more deterministic fashion. This may be desirable for some applications.

Having synchronized the reference frames, the system can then generate the Goal (or target) transformation that the robotic device is intended to match by scaling T_{S}_{_{U}}_{,H}, by α=({αᵣ, αₜ)}:

T_{S}_{_{R}}_{,G}=scale(T_{S}_{_{U}}_{,H},α)

This relation may help provide the goal pose for the robot's end effector 116 with respect to the robot synchronization frame S_{R}.

The use of a scaling factor α is optional. In some systems, the movements of the robotic device may be at generally 1:1 ratio with the movements of the user. If a scale factor is used it may be constant or may be variable. For example, the scale factor may vary as a function of the input space or based on other parameters. For example, it can act be selected based on the acceleration of the end effect controller, where if the user moves their hand relatively quickly, the scale factor is increased and the motion of the end effector is amplified. If a user moves the end effector controller more slowly, perhaps while performing a precise task, the scale factor can be automatically reduced and the motion of the end effector may be attenuated. Optionally, in addition to or as an alternative to automatic scaling, the system can be configured to be changeable between two or more static scaling modes allow the user to select a scaling mode or ratio. For example, the end effector controller may include a button, switch or other such user input device that a user can trigger while the system is in use to change between different pre-determined scaling factors. In some examples, the system may include static scaling, where the factor is selected with a button press, and a dynamic mode, where the rotation is up-scaled slightly as the user approaches the limits of the input space, which may help make the operation more comfortable.

Having determined the desired goal translation for the robotic device, the system can then formulate the suitable instructions that can be used to direct a given robotic device to position its end effector at this particular pose. The nature of the instructions generated, and the related outputs that are provided to the robotic device by the control system, can be specific to a given robotic device and/or general type of robotic devices. For example, the nature of the control scheme and the outputs to be sent to the robotic device may be based at least partially on the physical configuration of the robotic device and its manipulator, the nature of the control system used by the robotic device and the like. Optionally, the control system may be retrofitted onto an existing robotic device that was previously controlled using a different type of controller. For example, at least some of the system components can be incorporated into a robot control module that can be mounted to, and communicably linked with an existing robotic device. The robot control module may have a variety of different outputs that are suitable for connecting to and communicating with the inputs on a given robotic device. In such instances, the outputs of the system may be tailored to match the expected inputs for the robotic device. For example, the goal translation may be transformed into a series of joint inputs, and may be made to approximate the inputs that would have been provided by a joystick or other such controller in order to move the end effector of a given robotic device. Determining the nature of the outputs required may be done prior to attaching the system controller to the selected robotic device (i.e. at least partially customizing some aspects of the systems described herein). This may help facilitate the use of the present system with a variety of pre-existing robotic devices. It may also make the adoption of the described systems a generally “plug and play” type of operation for the owners/operators of the robotic device.

One example of a suitable control scheme, with a corresponding type of instructions that can be provided to the robotic device, include inverse kinematic controls, force control and velocity control.

To use these control methods, the system can utilize the transformation obtained in the steps described above. Kinematics equations can be defined with respect to R, rather than S_{R}, it can be desirable to find T_{R,G}:

T_{R,G}=T_{R,S}_{_{R}}T_{S}_{_{R}}_{,G}

where T_{R,S}_{_{R}} was recorded in the steps above.

This can then define the goal (target) pose for the end effector in the robot reference frame R:

$${T}_{R , G} = [ \begin{matrix}{R}_{R , G} & {t}_{G} \\ 0 & 1\end{matrix} ]$$

with R_{R,G} representing the goal rotation of the end effector, and t_{G} goal translation.

Depending on the operation mode (which itself may depend on the capabilities of the robot), the systems described herein may be configured to do at least some of the following control schemes: Impedance Control (e.g. if the robot is capable of controlling torque at each joint), Velocity Control (e.g. if the robot is (only) capable of controlling velocity of each joint) and Inverse Kinematics (e.g. if the robot is only capable of controlling the position of each joint).

The system 100 may be configured to utilize Impedance Control if the given robotic device is capable of controlling torque at each joint. The system may then be configured to use the dynamics of the robot manipulator 117 to apply a generalized cartesian force (force, and torque at the end effector) F, which may cause the end effector 116 to accelerate in a way which moves the end effector pose to match the goal pose. When stationary, this may have the effect of allowing the user to apply a force directly to the environment that is proportional to the difference between the end effector pose, and the goal pose. In combination with being able to adjust the damping, stiffness (and virtual inertia) of the robot this may help make interacting with the environment intuitive for the user. Where possible, this may be a preferred control scheme.

The system may be configured to utilize Velocity Control if the robotic device is (only) capable of controlling velocity of each joint in its manipulator. The system may utilize the Jacobian of the Forward Kinematics to find the joint velocities \dot{q} that move the end effector pose to match the goal pose.

The system may be configured to utilize Inverse Kinematics if the robotic device is only capable of controlling the position of each joint in its manipulator. The system can use inverse kinematics to find the angels q (or q*) that match the end effector pose to the goal pose.

The joints are then commanded to either apply the calculated torque, move at the calculated velocity, or move to the angles angels q (or q*).

The above method steps can then be repeated at a predetermined frequency/sampling rate while the system remains in its enabled state.

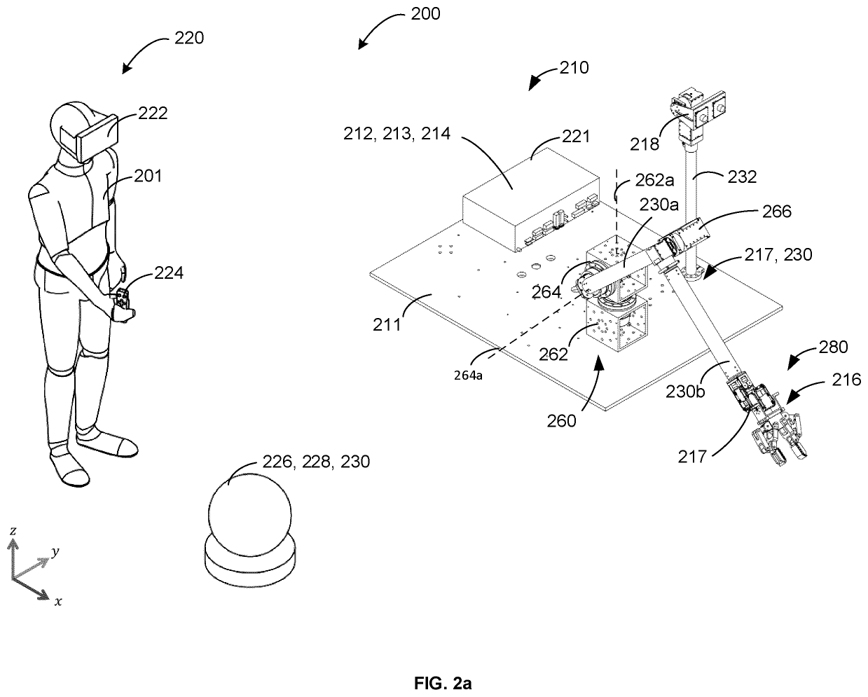

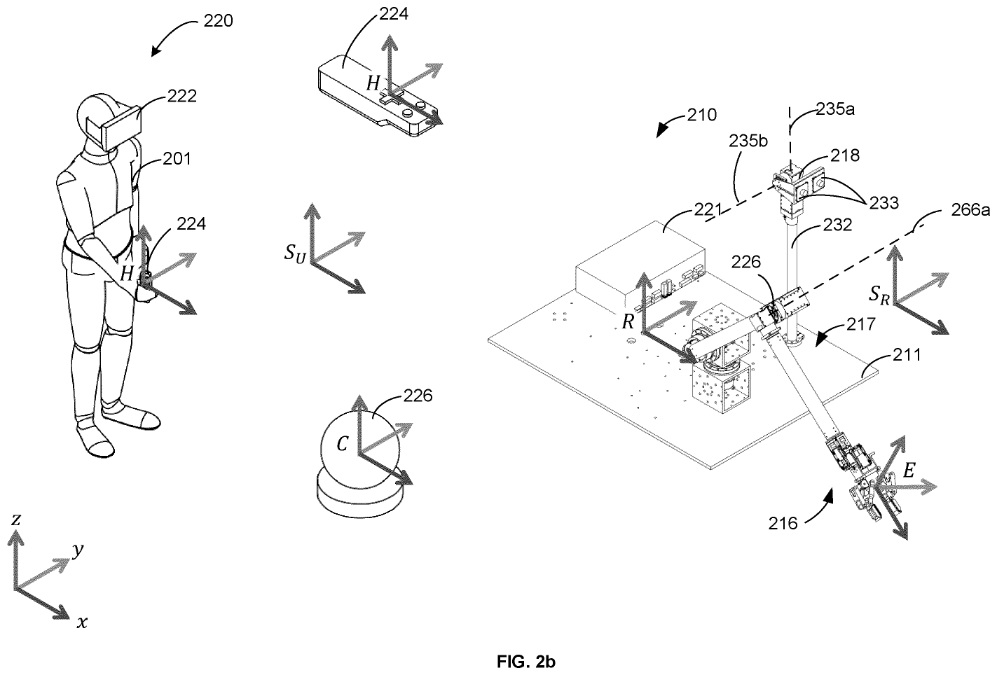

Referring now to FIGS. 2a and 2b, one embodiment of a robotic control system 200 that can be used as described herein is illustrated. The system 200 is generally analogous to the system 100, and like features are identified using like reference characters indexed by 100. In this embodiment, one example of a user interface apparatus 220 of the robotic control system 200 is illustrated. The user interface apparatus 220 includes a head-mounted display component 222 worn by an operator/user 201, and an end effector controller 224 held by the user 201. In this example, the user interface apparatus 220 uses a controller interface component 226 that is configured as a base station, and that can include the controller processor 230 and controller storage component 228. Alternatively, one or more of the interface component 226, the controller processor 230 and controller storage component 228 may be incorporated into the end effector controller 224 and/or display component 222, or may be remote from the head-mounted display 222 and the end effector controller 224.

An example robotic device 210 includes an imaging component 218 movably mounted to a base 211 via a support member 232, and a manipulator 217 comprising an articulated robotic arm 230 with a proximate end coupled to the base 211 via a manipulator base joint 260.

In the illustrated example, the imaging component 218 includes first and second cameras 233 that are positioned adjacent each other. This may help capture information in a manner that allows the imaging component 218 to capture 3D images of its surrounding environment. Preferably, the first and second cameras are movable relative to the base 211, and in this example can be pivoted relative to the support member 232 about a vertical axis 235a and a horizontal axis 235b using electric motors or the like to change the field of view captured by the imaging component 218 and displayed on the display apparatus 222.

In this illustrated example, the system is configured such that the movements of the imaging apparatus 218 are synced with, and driven by, the movements of the display component 222. For example, the user interface apparatus 120 can be configured to track the movement/position of the display apparatus 222 and then generate associated imaging control signals that can be transferred to the robot control apparatus and used to control the corresponding movement of the imaging apparatus 218 (i.e. when a user looks to the left the movement can be tracked and a corresponding “rotate left” control signal can be sent to the imaging apparatus 218).

Optionally, the connection between the user interface apparatus 120 and the imaging component 218 can remain active independent of the status of the connection between the end effector controller 224 and the end effector 216. For example, if the system is placed in its disabled mode, where control of the end effector 216 is suspended, the connection between the user interface apparatus 120 and the imaging component 218 may remain active such that a user may continue to be provided with images and manipulate the imaging component 218. This may help enable a user to continue to look around the environment and change the orientation of the imaging apparatus 218 while movement of the end effector 216 is disabled. Similarly, locomotion control of the robotic device 210 may remain active when the end effector control is in its disabled state.

The manipulator base joint 260 has a first base joint 262 for rotating the articulate arm 230 along the z-axis 262a and a second base joint 264 for rotating the articulate arm 230 along the y-axis 264a. The manipulator 217 extends from the proximate end to a distal end that includes an end effector 216.

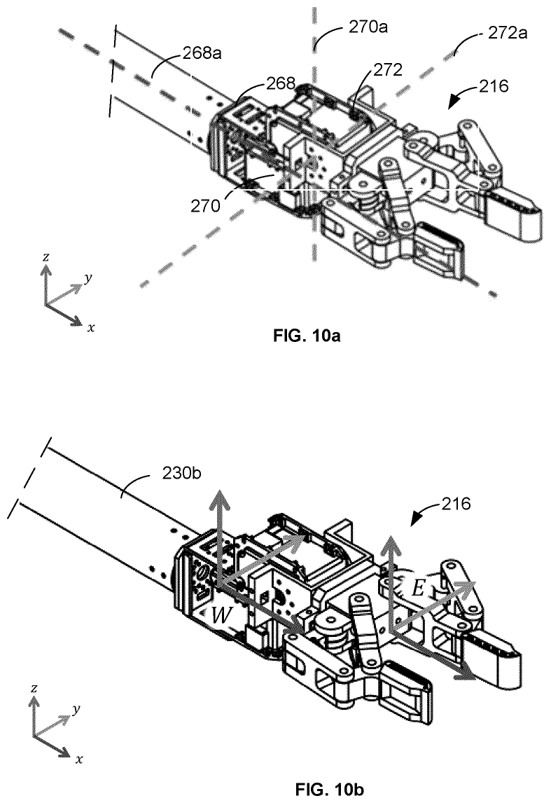

In this example, the articulate arm 230 includes a first arm portion 230a and a second arm portion 230b coupled to the first arm portion 230a with an intermediary joint 266, rotatable about axis 266a, and a wrist 280. Referring also to FIG. 10a, the wrist 280 includes a first wrist joint 268, a second wrist joint 270 and a third wrist joint 272. The first wrist joint 268 rolls the wrist 280 about the axis 268a (which may be the x-axis), the second wrist joint 270 applies a yaw along the axis 270a (which may be the z-axis) and the third wrist joint 272 pitches the wrist 280 about the axis 272a (which may be the y-axis).

In this example, the robotic device 210 is includes a generally integrated robot control module that forms part of the robotic device 210 and includes a device processor 212, a device storage component 213 and a device interface component 214 which are mounted within a housing 221 provided on the base 211. While not shown, a suitable locomotion apparatus can be mounted to the underside of the base 211 to help move the robotic device 210 across the ground.

It will be understood that the robotic device 210 shown in FIGS. 2a and 2b is only an example and the methods and systems described herein are not limited to the robotic device 210.

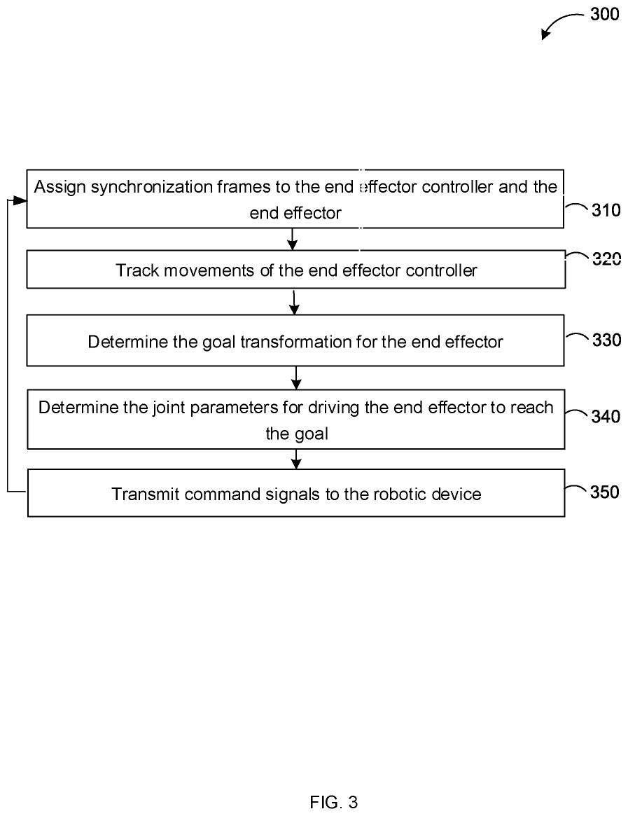

Reference is now made to FIG. 3, which is a flowchart of an example method 300 of controlling the robotic device 210. During operation of the robotic control system 200, the end effector 216 is moved to a goal position based on command signals generated by the user interface apparatus 120. To assist with the description of the method 300, reference will also be made to FIGS. 2a, 2b, and 5a to 16b.

During the operation of the robotic control system 200, the controller 220 can receive data signals from the robotic device 210 that can assist with the operation of the robotic device 210. For example, the controller 220 can receive imaging data from the imaging component 218 mounted to the robotic device 210. The controller 220 can also receive sensed data from sensors at the robotic device 210. The imaging data and/or sensed data can provide the operator 201 operating the robotic device 210 with more information about the surrounding of the robotic device 210.

At 310, the controller processor 230 assigns synchronization reference frames to the end effector controller 224 and the end effector 216.

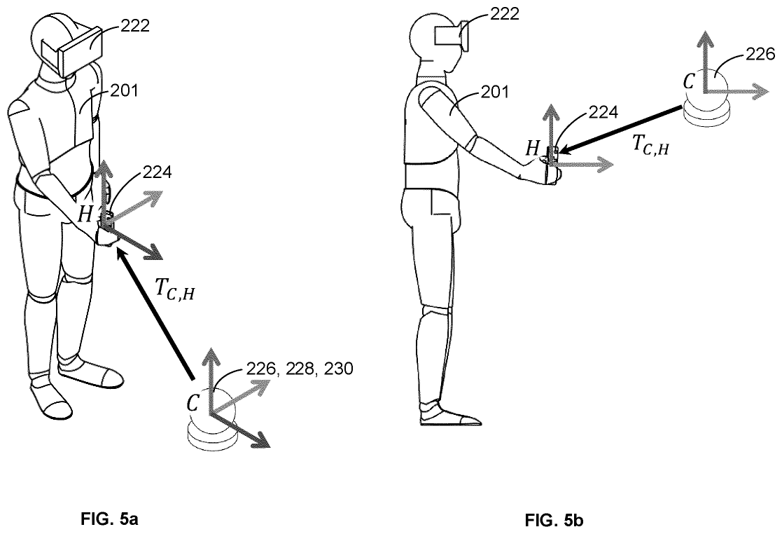

The synchronization reference frames act as offset reference frames. To describe the assignment of the synchronization reference frames to the end effector controller 224 and the end effector 216, the reference frames assigned to the controller 220 will be described with reference to FIGS. 5a to 7 and the reference frames assigned to the robotic device 210 will be described with reference to FIGS. 8 to 11c.

FIG. 5a is a perspective view of the operator 201 of FIGS. 2a and 2b and FIG. 5b is a side view of the operator 201. As shown in FIG. 5a, a hand reference frame H is assigned to a pose of the end effector controller 224. This hand reference frame His stored in at least the controller storage component 228. A controller reference frame C is also shown in FIG. 5a. The controller reference frame C can be arbitrary and it is used as the basis from which the other reference frames at the user interface apparatus 120 are considered. The controller reference frame C can be assigned to a base station, 226 in the illustrated example, at which the controller processor 230 may be stored, in some embodiments. A transformation matrix T_{C,H} transforms a pose in the hand reference frame H to the controller reference frame C.

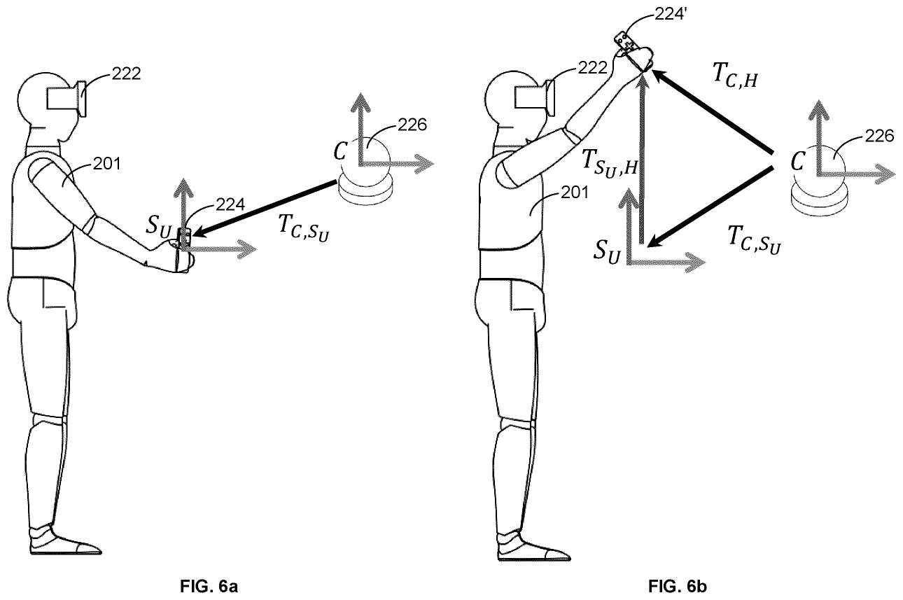

The transformation matrix T_{C,H} can be expressed by a 4×4 matrix, such as:

$${T}_{C , H} = [ \begin{matrix}{R}_{C , H} & {t}_{C , H} \\ {0}_{1 \times 3} & 1\end{matrix} ] \qquad Eqn . ( 1 )$$

where R_{C,H} is a 3×3 rotation matrix representing a relative orientation of the hand reference frame H with respect to the controller reference frame C, and t_{C,H} is the relative translation between the hand reference frame Hand the controller reference frame C, and O_{1×3} is a 1×3 matrix of zeros. As shown generally in FIG. 6a, a user synchronization reference frame S_{U} is assigned coincident with the hand reference frame H of FIG. 5b. A transformation matrix T_{C,S}_{_{U}} transforms a pose in the user synchronization reference frame S_{U} to the controller reference frame C and can be expressed as follows:

$${T}_{C , {S}_{U}} = [ \begin{matrix}{R}_{C , {S}_{U}} & {t}_{C , {S}_{U}} \\ {0}_{1 \times 3} & 1\end{matrix} ] \qquad Eqn . ( 2 )$$

where R_{C,S}_{_{U}} is a 3×3 rotation matrix representing a relative orientation of the user synchronization reference frame S_{U} with respect to the controller reference frame C, and t_{C,S}_{_{U}} is the relative translation between the user synchronization reference frame S_{U} and the controller reference frame C, and O_{1×3} is a 1×3 matrix of zeros. The transformation matrix T_{C,S}_{_{U}} allows the pose of the end effector controller 224 defined in the controller reference frame C to be expressed in the user synchronization reference frame S_{U}.

From FIGS. 5b and 6a, it can be seen that when the user synchronization reference frame S_{U} is first assigned, the transformation matrix T_{C,S}_{_{U}} is the same as transformation matrix T_{C,H}.

FIG. 6b shows the end effector controller 224′ at a subsequent pose. A transformation matrix T_{S}_{_{U}}_{,H} transforms the subsequent pose in the user reference frame H to the user synchronization reference frame S_{U}. The transformation matrix T_{S}_{_{U}}_{,H} can be expressed as follows:

T_{S}_{_{U}}_{,H}=T_{C,}_{_{S}}_{U}⁻¹T_{C,H}. Eqn. (3)

As shown in FIG. 6b, the transformation matrix T_{S}_{_{U}}_{,H} represents an offset between the user synchronization reference frame S_{U} and the user reference frame H.

If desired for specific applications, the rotation component of the hand reference frame H can be set to coincide exactly with the rotation of the end effector controller:

rot(T_{S}_{_{U}}_{,H})=rot(T_{C,H})

This would allow for the end effector to always be oriented with respect to a constant reference frame. That is if a user holds the end effector controller in a specific orientation, the end effector would also consistently attain a matching (possibly scaled) orientation. This can be useful if for example orienting the end effector consistently up, or forward is important such as for construction tasks.

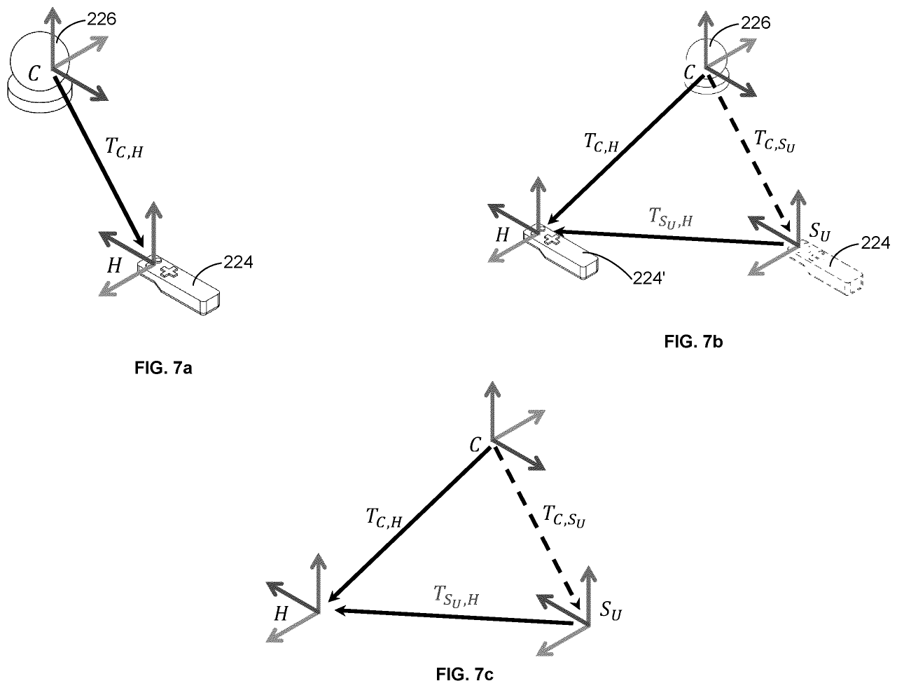

FIGS. 7a-7c illustrates example reference frames at the user interface apparatus 120.

The user synchronization reference frame S_{U} is assigned coincident to a hand reference frame H of the end effector controller 224 at an initial pose (FIG. 7a). The transformation matrix T_{C,S}_{_{U}} defines the user synchronization reference frame S_{U} relative to the controller reference frame C. The end effector controller 224′ is shown in FIG. 7b having been moved to at a subsequent pose by the user. A transformation matrix T_{S}_{_{U}}_{,H} represents an offset between the user synchronization reference frame S_{U} and the user reference frame H, and can be determined with Eqn. (3).

Reference will now be made to FIGS. 8 to 11c for describing the reference frames at the robotic device 210.

FIG. 8 shows the robotic device 210 of FIGS. 2a and 2b annotated with reference frames. The controller processor 230 assigns an end effector reference frame E to the end effector 216, a wrist reference frame W to the wrist 280, and a manipulator reference frame M to the manipulator 217, which can be located at the manipulator base joint 260 and is placed at the intersection of the axes 262a and 264a. An arbitrary robot reference frame R is also assigned to the robotic device 210. Similar to the controller reference frame C, the robot reference frame R is used as a basis from which the other reference frames at the robotic device 210 are considered. While this placement may be convenient for a given robotic device, the manipulator reference frame M may alternatively be placed at the (fixed) joint of base and first robot joint. In the illustrated example the manipulator reference frame M is placed at the intersection because it helps simplify the kinematics for the specific robot device shown, but does not materially affect the dynamics.

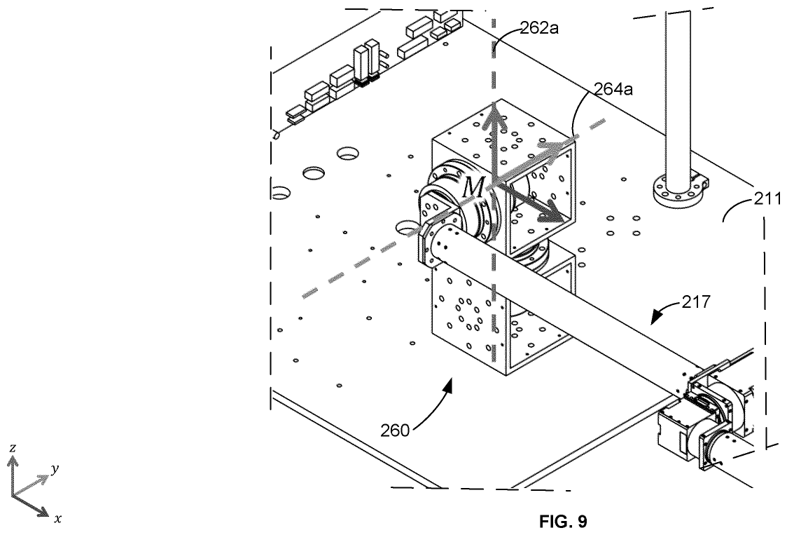

An example process of assigning the manipulator reference frame M to the manipulator base joint 260 and the wrist reference frame W to the wrist 280 will be described with reference to FIGS. 9 to 10b.

FIG. 9 is an enlarged view of a portion of the robotic device 210 of FIG. 8, including the manipulator base joint 260. As shown in FIG. 9, the manipulator reference frame M is in this example defined at the intersection of the two axes of rotation of the manipulator base joint 260, namely axes 262a and 264a.

FIG. 10a is an enlarged view of the wrist 280 and the end effector 216. As described, the wrist 280 has three wrist joints 268, 270 and 272 and each wrist joint 268, 270 and 272 operates in a different axis of rotation, namely 268a, 270a and 272a, respectively. In the example shown in FIG. 10a, the three axes of rotation 268a, 270a and 272a, do not intersect at one point and so, the wrist reference frame W is positioned approximate to the intersections of two of the axes of rotation 268a, and 270a.

The assignment of the robot synchronization reference frame S_{R} will be described with reference to FIGS. 11a to 11c.

The robot synchronization reference frame S_{R} is assigned to a current pose of the end effector 216 when system 200 is put into its enabled mode and preferably at the same time the user synchronization reference frame S_{U} is assigned to the end effector controller 224. Similar to how the movement of the end effector controller 224 is tracked relative to the user synchronization reference frame S_{U}, the movement of the end effector 216 will be executed with respect to the robot synchronization reference frame S_{R}.

FIG. 11a is a side view of a portion of the robotic device 210 of FIG. 8 at an initial pose. A transformation matrix T_{R,E} transforms a pose in the end effector reference frame E to the robot reference frame R. The transformation matrix T_{R,E} be expressed by a 4×4 matrix, such as:

$${T}_{R , E} = [ \begin{matrix}{R}_{R , E} & {t}_{R , E} \\ {0}_{1 \times 3} & 1\end{matrix} ] \qquad Eqn . ( 4 )$$

where R_{R,E} is a 3×3 rotation matrix representing a relative orientation of the end effector reference frame E with respect to the robot reference frame R, and t_{R,E} is the relative translation between the end effector reference frame E and the robot reference frame R, and O_{1×3} is a 1×3 matrix of zeros.

When the user synchronization reference frame S_{U} is assigned to the end effector controller 224, the controller processor 230 assigns the robot synchronization reference frame S_{R} to the current pose of the end effector 216, which is the initial pose shown in FIG. 11a in this example. By assigning the user synchronization reference frame S_{U} and the robot synchronization reference frame S_{R} at the same time and then tracking the movements of the end effector controller 224 thereafter, the controller processor 230 can ensure that the control of the end effector 216 is synched with the movement at the end effector controller 224.

FIG. 11b shows FIG. 11a annotated with the robot synchronization reference frame S_{R}.

A transformation matrix T_{R,S}_{_{R}} transforms a pose in the robot synchronization reference frame S_{R} to the robot reference frame R and can be expressed as follows:

$${T}_{R , {S}_{R}} = [ \begin{matrix}{R}_{R , {S}_{R}} & {t}_{R , {S}_{R}} \\ {0}_{1 \times 3} & 1\end{matrix} ] \qquad Eqn . ( 5 )$$

where R_{R,S}_{_{R}} is a 3×3 rotation matrix representing a relative orientation of the robot synchronization reference frame S_{R} with respect to the robot reference frame R, and t_{R,S}_{_{R}} is the relative translation between the robot synchronization reference frame S_{R} and the robot reference frame R, and O_{1×3} is a 1×3 matrix of zeros. The transformation matrix T_{R,S}_{_{R}} is stored at least in the controller storage component 228.

From FIGS. 11a and 11b, it can be seen that when the robot synchronization reference frame (S_{R}) is first assigned (i.e. when the system is first transitioned from disabled mode to enabled mode), the transformation matrix T_{R,S}_{_{R}} is the same as transformation matrix T_{R,E}.

FIG. 11c shows the end effector 216 having been moved to at a subsequent pose. A transformation matrix T_{S}_{_{R}}_{,E} transforms the subsequent pose in the end effector reference frame E to the robot synchronization reference frame S_{R}. The transformation matrix T_{S}_{_{R}}_{,E} can be expressed as follows:

T_{S}_{_{R}}_{,E}=T_{R,S}_{_{R}}⁻¹T_{R,E}. Eqn. (6)

As shown in FIG. 11c, the transformation matrix T_{S}_{_{R}}_{,E} represents an offset between the end effector reference frame E and the robot synchronization reference frame S_{R}.

After assigning the user synchronization reference frame S_{U} and the robot synchronization reference frame S_{R}, the controller processor 230 can proceed to track the movements of the end effector controller 224 (at step 320).

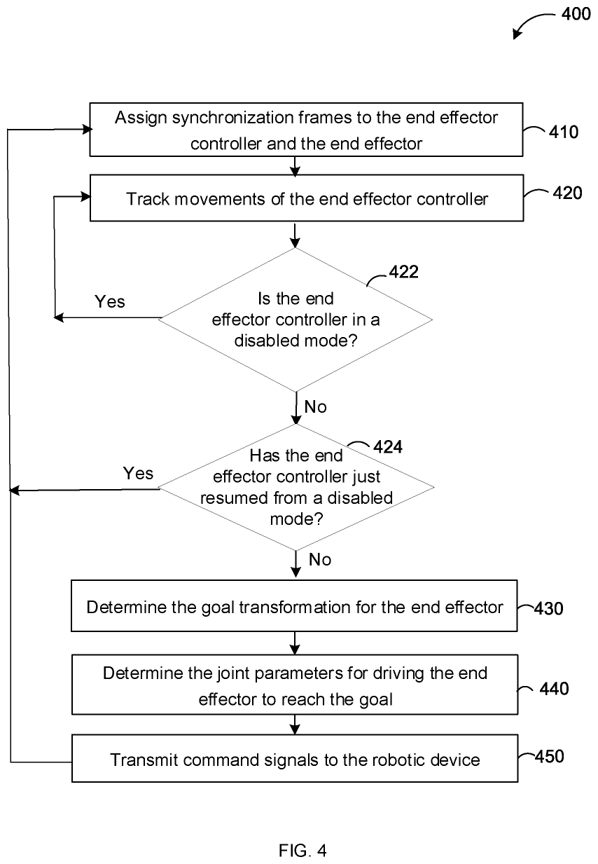

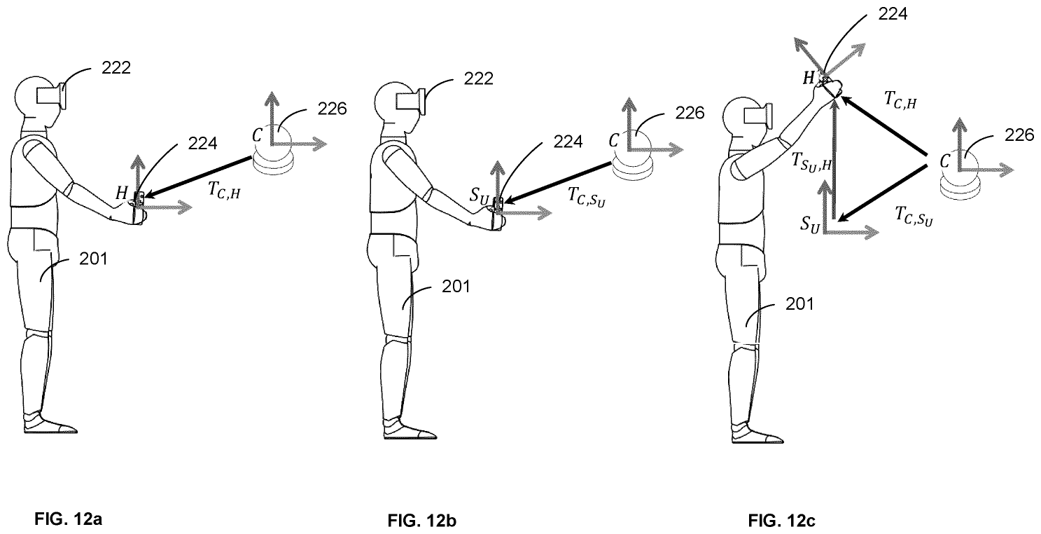

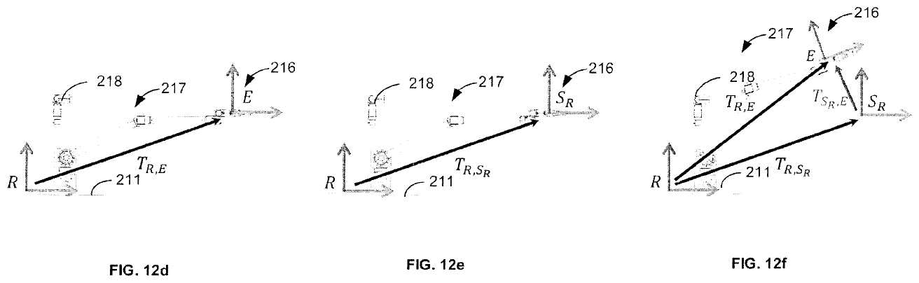

In some embodiments, the end effector controller 224 can enter a disabled mode during which movement at the end effector controller 224 does not cause corresponding movement at the end effector 216. FIG. 4 shows an example method 400 of controlling the robotic device 210 in which the end effector controller 224 can enter the disabled mode. Implementation of this method is described with reference to FIGS. 12a-f.

In this method 400 the controller processor 230 assigns the synchronization reference frames at step 410 and thereafter, tracks the movements of the end effector controller 224 at step 420. In step 420, the user 201 has an end effector controller 224, to which a reference frame, referred to as the hand frame H is rigidly attached. The pose of the end effector controller 224 is then tracked with respect to the base station 226 (which includes the controller storage component and controller processor) and control frame C. The pose of frame H as related to frame C is obtained as the transformation matrix T_{C,H} (FIG. 12a).

Tracking of the end effector controller 224 can be done while the system 200 (or 100 or other system) is in its disabled mode, such that movement of the end effector controller 224 is NOT translated into instructions for the end effector 216. That is, the user 201 can move her hand freely and the manipulator 217 will not move.

At 422, the controller processor 230 determines whether the end effector controller 224 is in its disabled mode. For example, the operator 201 can trigger the disabled mode by causing a disengagement signal to be sent to the controller processor 230. The disengagement signal can be generated in response to an activation of a mode selection button at the end effector controller 224 or by alternative methods, such as verbal commands from the operator 201. The controller processor 230 may continue to track the movement of the end effector controller 224 during the disabled mode, for example by repeating steps 420-422.

By enabling the end effector controller 224 to enter a disabled mode, the operator 201 has the flexibility to rest and/or adjust his hand position without affecting the operation of the robotic device 210. The operator 201 can also take advantage of the disabled mode to reposition the end effector controller 224 to minimize strain. With the disabled mode, the operator 201 will not be constrained by his physical space and extension.

If the end effector controller 224 is in the disabled mode, the controller processor 130 can continue to track movements of the end effector controller 224 (at 420). To exit the disabled mode, the end effector controller 224 transmits an engagement signal to the controller processor 230 to resume transmitting motion commands to the robot.

If the end effector controller 224 is not in the disabled mode, the controller processor 230 determines at 424 whether the end effector controller 224 has just resumed from a disabled mode. If the end effector controller 224 has just resumed from a disabled mode, for example if the user 201 triggers the system to transition into its engage mode, the controller processor 230 then proceeds to step 410. For example, the controller processor 230 can determine that the end effector controller 224 just resumed from a disabled mode upon receipt of the engagement signal. The controller processor 230 can then assign the robot synchronization reference frame S_{R} to the current pose of the end effector 216, and the user synchronization reference frame S_{U} to the current pose of the end effector controller 224.

If the end effector controller 224 did not just resume from a disabled mode, i.e. was previously in its engaged mode, the controller processor 230 proceeds to step 430 without having to re assign the user synchronization reference frame S_{U} or the robot synchronization reference frame S_{R}.

In method 300, the controller processor 230 can assign the synchronization reference frames during the operation of the end effector controller 224, and/or at a predefined time period or in response to other trigger events. In contrast, in method 400, the controller processor 230 preferably assigns the synchronization reference frames initially and when the end effector controller 224 resumes from a disabled mode. After assigning the synchronization reference frames, the controller processor 230 continues to track the movements of the end effector controller 224 until it is determined that the end effector controller 224 has not just resumed from a disabled mode (at 424).

Having established that the system 200 is in its enabled mode, and that movements of the end effector controller 224 are intended to be transferred to the end effector 216, the method 300 and 400 follow analogous method steps 330-350 and 430-450, which are explained with reference to steps 430-450 and FIGS. 12a-f. The same description can be applied to steps 330-350.

At 430, the controller processor 230 determines the goal transformation for the end effector 216.

The target transformation (T_{S}_{_{R}}_{,G}) defines a target for the end effector 216 based on the relative movement tracked by the end effector controller 224.

In this illustrated example, during step 410 the controller processor 230 assigns a user synchronization reference frame S_{U} to an initial pose of the end effector controller 224 (FIG. 12b) and a robot synchronization reference frame S_{R} o an initial pose of the end effector 216 (FIG. 12e). At the next time step the operator 201 moves the end effector controller 224 from its initial position which was coincident with the user synchronization reference frame S_{U} to a new, goal position, with the hand reference frame H being rigidly attached to the end effector controller (FIG. 12c). The relative movement can be represented by the transformation matrix T_{S}_{_{U}}_{,H}.

Referring now to FIGS. 12e and 12f, a goal transformation T_{S}_{_{R}}_{,G} is then defined for the robotic device 210. The goal transformation T_{S}_{_{R}}_{,G} defines a goal for the end effector 216 based on the relative movement tracked by the end effector controller 224. Therefore, the goal transformation T_{S}_{_{R}}_{,G} can be defined based on the transformation matrix T_{S}_{_{U}}_{,H}. Using Eqn. (3), the goal transformation T_{S}_{_{R}}_{,G} can be expressed as follows:

T_{S}_{_{R}}_{,G}T_{S}_{_{U}}_{,H}T_{C,S}_{_{U}}⁻¹T_{C,H} Eqn. (7)

In some embodiments, the goal transformation T_{S}_{_{R}}_{,G} applied at the end effector controller 224 can be scaled according to operator preferences. The operator 201 may adjust the scaling factor when switching between a coarse task to a fine task (or vice versa), for example. The goal transformation T_{S}_{_{R}}_{,G} can optionally be scaled by a factor, α={(αₜ, αᵣ}, according to the below expression:

T_{S}_{_{R}}_{,G}=scale(T_{S}_{_{U}}_{,H},α)=scale(T_{C,S}_{_{U}}⁻¹T_{C,H},α) Eqn. (8)

where αₜ and αᵣ are some functions that scale translation and rotation respectively. The functions can be static integers to simply increase or decrease the speed of motion, or more complex relations allowing, for example, for the end effector to move more quickly than the user when the user moves above a certain threshold, and slowing the manipulator down below the speed of the user when the user moves slower than a different threshold, or any other function that may be desirable.

For example, in an emergency response scenario, the operator 201 operates the end effector controller 224 to control the end effector 216 for performing coarse tasks, such as exploring the environment, shining a light with the end effector 216, and/or clearing obstructions. A larger scaling factor may be applied to these coarse tasks to help provide relatively fast, large scale movements. For example, a scaling factor of αₜ=2 doubles the motion at the end effector controller 224. However, the operator 202 may later require the end effector 216 to perform finer tasks that require more precise actions, such as grasping a small object, operating equipment, opening a bag, or using a tool. A smaller scaling factor can then be used when performing these finer tasks. For example, a scaling factor of αₜ=0.25 reduces the motion at the end effector controller 224 to a quarter. By enabling the operator 201 to adjust the scaling factor, the operator 201 can customize the operation of the robotic device 110 for different situations and environments.

At 440, the system, for example using controller processor 230 performs suitable control calculations and can then move the joints or applies torques to help the end effector 216 reach its desired goal (FIGS. 12d and 12f).

The particular commands/parameters for driving a given manipulator 217 and end effector 216 for a given robotic device can be determined and provided to the robotic device 210 using any suitable method or process. Some examples of suitable control methods may include torque or impedance control, velocity control, position control, inverse kinematics and the like. Which control method is used in a given embodiment may be determine using a variety of factors, including the nature of the robotic device, the input requirements of a given robotic device and the like.

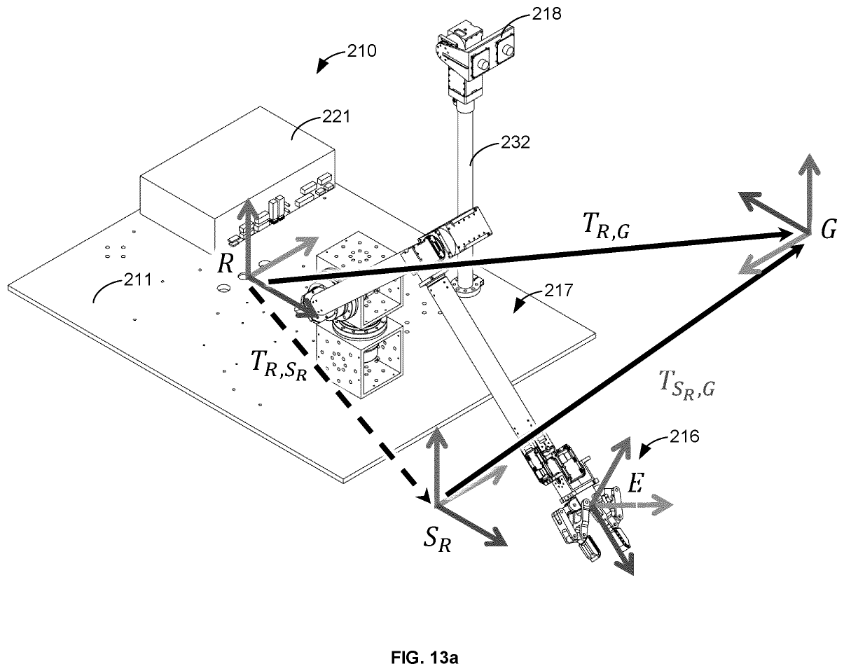

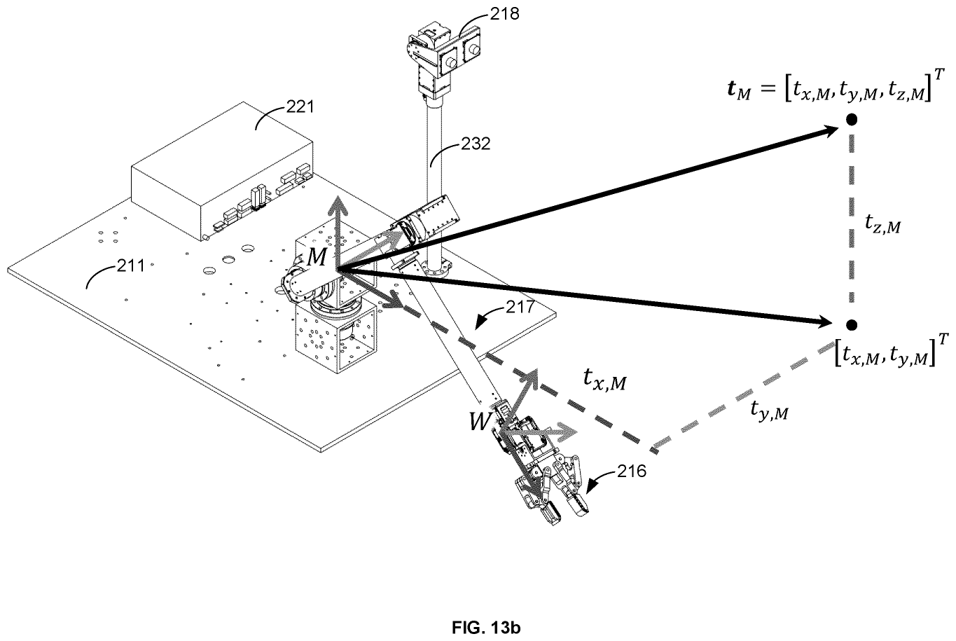

Referring to FIGS. 13a-16b, one example of a control in the described systems and methods, the joint parameters for driving the end effector 216 to the goal can be determined by applying inverse kinematics to a goal transformation matrix, or other suitable method/scheme based on the available robotic device control modes.

For example, kinematics equations can be constraint equations that can help define a configuration of a robotic device 210 based on positions at one or more joints. The kinematic equations can relate a set of joint angles q (where q=[q₁, q₂, . . . , qₙ]) of a robotic device 210, such as an articulate arm to the final pose of the end effector. A Jacobian matrix J(q), such as the below:

\dot{x}=J(q)\dot{q} Eqn. (9)

can relate the rate of change of the joint angles to the linear and angular velocities of the end effector 216, where \dot{x}=[\dot{x}, \dot{y}, ż, ωₓ, ω_{y}, ω_{z}]^{T}.

When the kinematics equations are applied for forward kinematics, specific values are defined for the set of joint angles to determine a pose of the articulate arm 230. For example, the transformation matrix T_{R,E}(q) transforms a pose from the end effector reference frame E to the robot reference frame R using the joint angles q of the articulate arm 230.

Inverse kinematics, on the other hand, can determine the values of the joint parameters from a goal defined for the articulate arm 230. The inverse kinematic problem can be solved numerically through optimization or by using an inverse of a forward kinematics Jacobian matrix. The inverse kinematics problem can also be solved by generating an analytic inverse kinematics model for the robotic device 210 through algebraic manipulation or by examining a geometric structure of the robotic device 210.

Each inverse kinematics model is specific to a robotic arm of a robotic device 210. When a different robotic arm is mounted to the robotic device 210, a different inverse kinematics model will need to be developed.

Similarly, dynamic equations can be constraint equations that can relate the state of a robotic device 210 and the rate of change of its kinematic parameters to the torques and forces applied by, or to, the robotic device. The dynamics of a general robotic system commonly take the following form:

τ=M(q)\ddot{q}+V(q,\dot{q})+D(\dot{q})+G(q) Eqn. (9a)

where τ is a vector of torques seen by each joint of the robot, M(q) is the inertia matrix of the robot at a given configuration q, V(q, \dot{q}) is a vector of Coriolis and centripetal torques, D(\dot{q}) is a vector of viscous, friction and other joint velocity dependent torques, and G(q) is a vector of gravity, and other joint position dependent torques.

Reference will now be made to FIG. 13a, which shows the robotic device 210 with a goal reference frame G annotated therein. The goal is defined by the relative movement tracked by the end effector controller 224 and corresponds to the transformation matrix T_{S}_{_{U}}_{,H} or a scaled version of the transformation matrix T_{S}_{_{U}}_{,H}.

The goal transformation matrix T_{S}_{_{R}}_{,G} is with respect to the robot synchronization reference frame S_{R}. Since the kinematic equations in this example are defined with respect to the robot reference frame R, a goal transformation matrix T_{R,G} with respect to the robot reference frame R is defined as follows:

T_{R,G}=T_{R,S}_{_{R}}T_{S}_{_{R}}_{,G} Eqn. (10)

where the transformation matrix T_{R,S}_{_{R}} was assigned and stored at step 410 (or 310). The goal transformation matrix T_{R,G} can be expressed as follows:

$${T}_{R , G} = [ \begin{matrix}{R}_{R , G} & {t}_{R , G} \\ {0}_{1 \times 3} & 1\end{matrix} ] \qquad Eqn . ( 11 )$$

where R_{R,G} is a 3×3 rotation matrix that represents a goal rotation of the end effector 216 and t_{R,G} represents a goal translation, and O_{1×3} is a 1×3 matrix of zeros. The goal transformation matrix T_{R,G}, therefore, represents the offset between the robot reference frame R and the goal reference frame G. The system can then generate the required control signals for the robotic device 210.

When the robotic device 210 utilizes as position-based control mode, the system may determine joint parameters, using the inverse kinematics model of the articulate arm 230.

First, in this example, the controller processor 230 solves for the joint angle (q₁) of the first base joint 262.

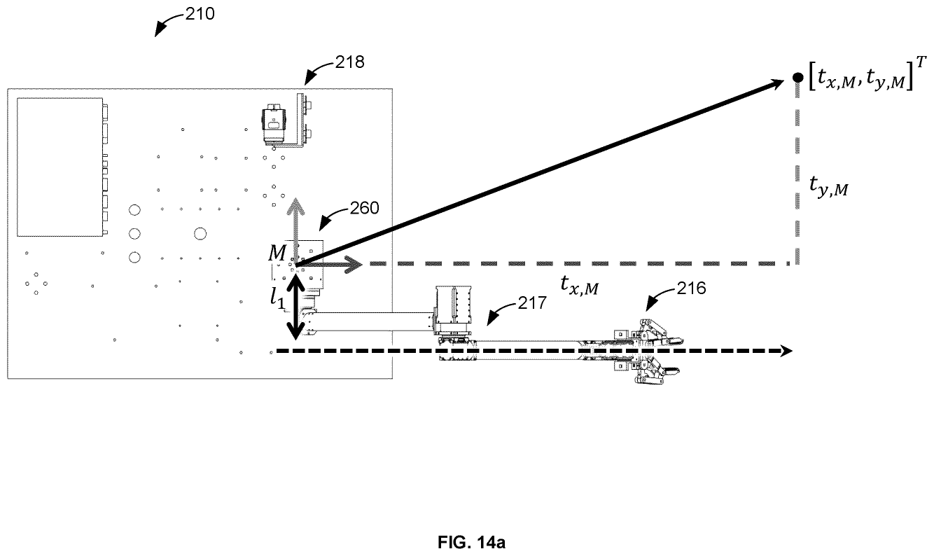

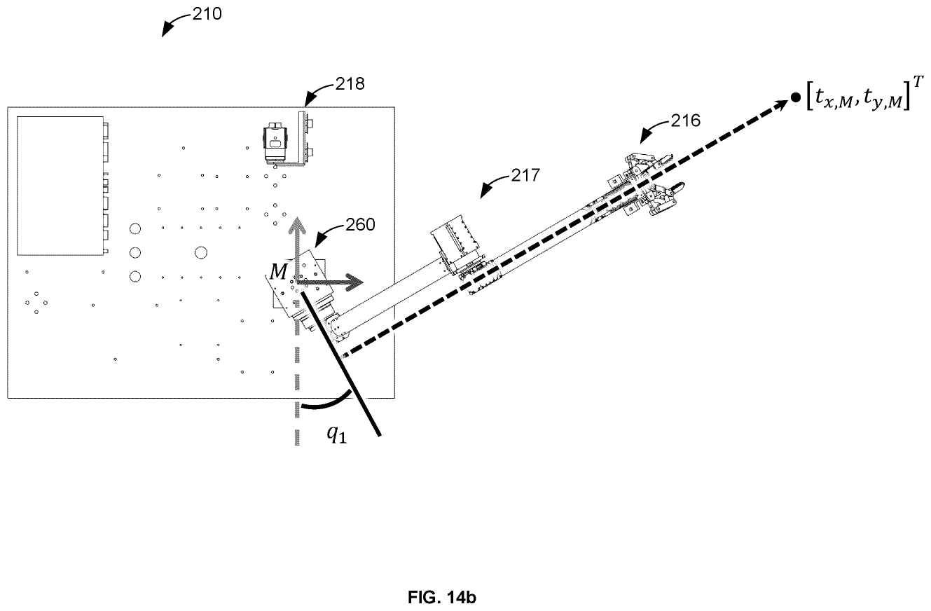

As shown generally in FIGS. 13a and 13b, the controller processor 230 transforms the goal position from the robot reference frame R to the manipulator reference frame M (FIG. 13b). In the manipulator reference frame M, the goal position is expressed as: t_{M}=[t_{x,M}, t_{y,M}, t_{z,M}]^{T}. The controller processor 230 then projects the goal position into the x-y plane by disregarding the ‘z’ component. As shown in FIG. 13b, the goal position without the ‘z’ component is expressed as [t_{x,M}, t_{y,M}]. FIG. 14a shows a top view of FIG. 13b.

The joint angle (q₁) of the first base joint 262 can be determined as follows:

$${q}_{1} = \frac{π}{2} - φ + ψ \qquad Eqn . ( 12 )$$

where

$$ψ = atan ( \frac{{t}_{y , M}}{{t}_{x , M}} ) , φ = acos ( \frac{{l}_{1}}{\sqrt{{t}_{x , M}^{2} + {t}_{y , M}^{2}}} ) ,$$

and l₁ is a distance along the second base joint's 264 axis of rotation from the first base joint's 262 axis of rotation to the first wrist joint's axis of rotation 268a (see FIG. 10a). As shown in FIG. 14b, the first base joint 262 is rotated by the joint angle (q₁).

The goal position is then rotated into the reference frame of the first base joint 262:

t₁=R_{1,M}(q₁)t_{M} Eqn. (13)

where R_{1,M}(q₁) represents a relative orientation of the manipulator reference frame M with respect to the reference frame of the first base joint 262 and t₁ represents the goal position of the wrist 280 in the reference frame of the first base joint 262.

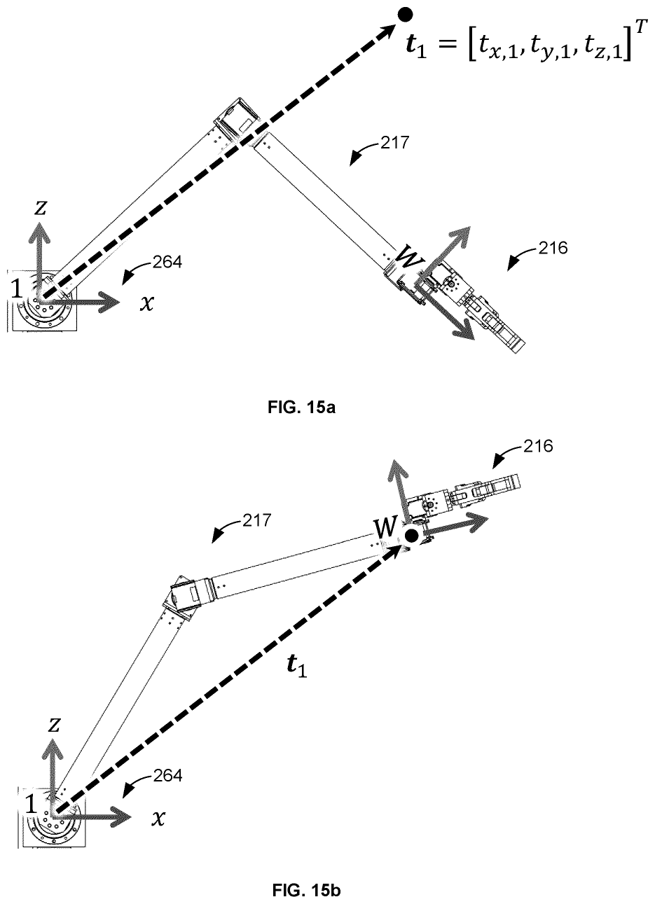

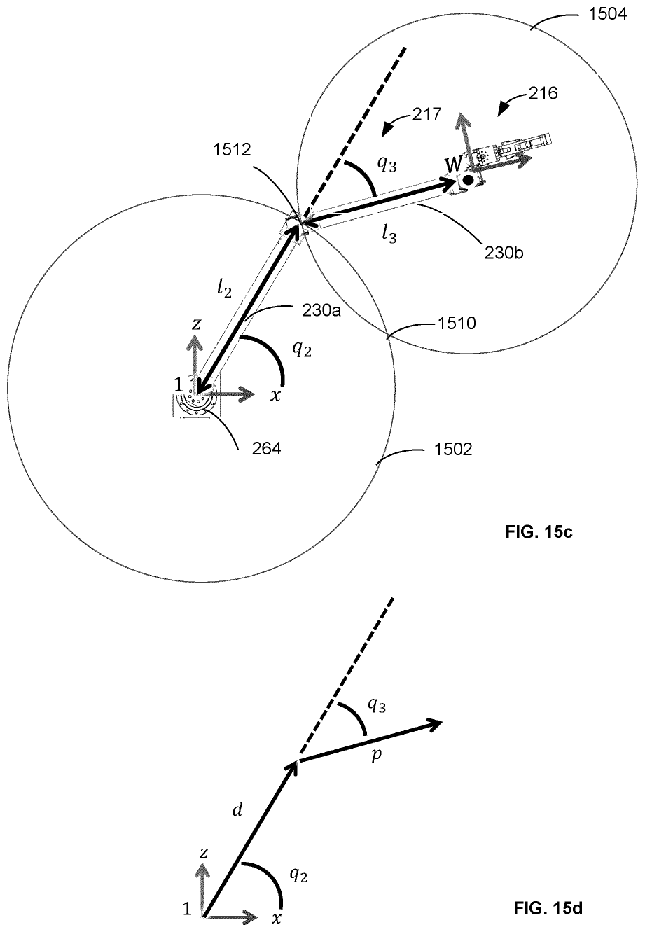

The controller processor 230 then solves for the joint angle (q₂) of the second base joint 264 and the joint angle (q₃) of the intermediary joint 266 by first rotating into the reference frame of the first joint 262. Reference will now be made to FIGS. 15a to 15d.

FIG. 15a shows, the articulate arm 230 in the reference frame of the first base joint 262. The goal position in the reference frame of the first base joint 262 can be represented as: t₁=[t_{x,1}, t_{y,1}, t_{z,1}]^{T}. t_{y,1} is zero since the articulate arm 230 is aligned with the goal position after being rotated at the first base joint 262 by the joint angle (q₁). FIG. 15b shows the manipulator 217 rotated according to joint angles q₂ and q₃.

FIGS. 15c and 15d show diagrams for solving the joint angles q₂ and q₃.

The joint angles q₂ and q₃ can be solved by modeling two circles 1502, 1504 along the x-z plane of the first base joint 262. For the joint angle q₂, a first circle 1502 is modelled with its center at an origin of the manipulator first base joint reference frame (1) (which is coincident with the origin of the manipulator reference frame M and a radius that corresponds to a length of the first arm portion 230a (l₂). For the joint angle q₃, a second circle 1504 is modeled with its center at the goal position t₁ and a radius that corresponds to a length of the second arm portion 230b (l₃).

When the modeled circles 1502, 1504 do not intersect, the goal position is outside of the reach of the robotic device 210. When the modeled circles 1502, 1504 intersect at one point, the goal position is at the maximum reach of the articulate arm 230. When the modeled circles 1502, 1504 intersect at two points, such as 1510 and 1512 of FIG. 15c, the goal position is within the reach of the articulate arm 230.

The robotic device 210 may be configured to cease operating when the goal position is outside its reach and may be designed to avoid singularities. For example, the controller processor 230 defines a safe region for the goal position. If the goal position indicated by the end effector controller 224 exceeds the safe region, the controller processor 130 identifies a position within the safe region that is closest to that goal position.

Continuing with reference to FIG. 15c, the position of each of the two intersection points a(x,z) 1512 and b(x,z) 1510 can be determined as follows:

$${a}_{x} = \frac{{t}_{x , 1} k}{\vert {t}_{1} \vert} + \frac{{t}_{z , 1}}{\vert {t}_{1} \vert} \sqrt{{l}_{2}^{2} - {k}^{2}} \qquad Eqn . ( 14 )$$

$${a}_{z} = \frac{{t}_{z , 1} k}{\vert {t}_{1} \vert} - \frac{{t}_{x , 1}}{\vert {t}_{1} \vert} \sqrt{{l}_{2}^{2} - {k}^{2}} \qquad Eqn . ( 15 )$$

$${b}_{x} = \frac{{t}_{x , 1} k}{\vert {t}_{1} \vert} - \frac{{t}_{z , 1}}{\vert {t}_{1} \vert} \sqrt{{l}_{2}^{2} - {k}^{2}} \qquad Eqn . ( 16 )$$

$${b}_{z} = \frac{{t}_{z , 1} k}{\vert {t}_{1} \vert} + \frac{{t}_{x , 1}}{\vert {t}_{1} \vert} \sqrt{{l}_{2}^{2} - {k}^{2}} \qquad Eqn . ( 17 )$$

where

$$k = \frac{{\vert {t}_{1} \vert}^{2} + {l}_{2}^{2} - {l}_{3}^{2}}{2 \vert {t}_{1} \vert} .$$

To avoid collision, the controller processor 230 selects a higher of the two intersection points a(x,z) 1512 and b(x,z) 1510 as follows:

$$\begin{matrix}c = {t}_{1} \times {[ {a}_{x} , 0 , {a}_{z} ]}^{T} & Eqn . ( 18 ) \\ u = \{ \begin{matrix}if {c}_{y} < 0 & {[ {a}_{x} , 0 , {a}_{z} ]}^{T} \\ if {c}_{y} > 0 & {[ {b}_{x} , 0 , {b}_{z} ]}^{T}\end{matrix} & Eqn . ( 19 ) \\ v = {t}_{1} - u & Eqn . ( 20 )\end{matrix}$$

where u is the vector from the centre of the first circle 1502 to the selected intersection point, and v is the vector from the selected intersection point to the centre of the second circle 1504, as shown in FIG. 15d.

The joint angles q₂ and q₃ can be determined as follows:

q₂=arctan(u_{z},uₓ) Eqn. (21)

q₃=q₂−arctan(v_{z},vₓ) Eqn. (22)

After determining the joint angles q₂ and q₃, the angles at the three wrist joints 268, 270, and 272 can be determined for aligning the end effector reference frame E with the goal orientation. To determine the orientation of the wrist 280, which is coupled to the second arm portion 230b relative to the robotic reference frame R, the rotation matrix, R_{R,W}, as defined below, is solved.

R_{R,W}=R_{z}(q₁)R_{y}(q₂−q₃) Eqn. (23)

R_{R,W} defines the orientation of the wrist 280 relative to the robotic reference frame R, and where R_{y}, and R_{z} are rotations about the y, and z axes respectively.

The relative rotation of the goal reference frame G (FIG. 13a) with respect to the wrist 280 (R_{W,G}) is defined as follows:

R_{W,G}=R_{R,W}^{T}R_{R,G} Eqn. (24)

where R_{R,G} represents the goal orientation of the end effector 216 with respect to the robot reference frame R.

Because of the construction of the wrist 280 and the orientation of the axes of rotation of joints 268, 270, and 272, the rotation matrix R_{W,G} corresponds to the combined rotation of the wrist joints 268, 270, and 272. The sequence of rotation of the wrist joints 268, 270 and 272 is such that:

R_{W,G}=Rₓ(q₄)R_{z}(q₅)R_{y}(q₆)=R_{R,W}^{T}R_{R,G} Eqn. (25)

Where Rₓ, R_{y}, and R_{z} are rotations about the x, y, and z axes respectively.

The joint angles q₄, q₅, and q₆ of the wrist 280 can be determined as follows:

$$\begin{matrix}{q}_{4} = atan ( \frac{{R}_{W , G} [ 3 , 2 ]}{{R}_{W , G} [ 2 , 2 ]} ) & Eqn . ( 26 ) \\ {q}_{5} = asin ( {R}_{W , G} [ 1 , 2 ] ) & Eqn . ( 27 ) \\ {q}_{6} = atan ( \frac{{R}_{W , G} [ 1 , 3 ]}{{R}_{W , G} [ 1 , 1 ]} ) & Eqn . ( 28 )\end{matrix}$$

where R[i,j] refers to the ith row and jth column of a matrix R. The controller processor 130 prevents each of the joint angles q₄, q₅, and q₆ from reaching singularity, which is when the joint angles q₄, q₅, and q₆ approaches π/2.

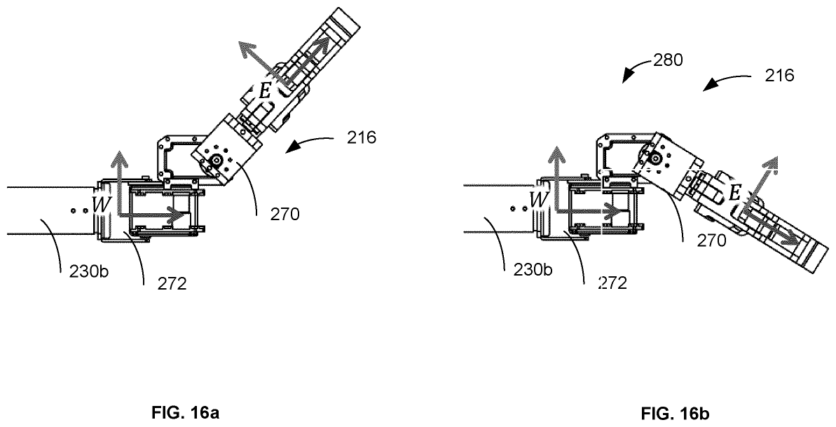

As shown in FIG. 8, the origin of the wrist reference frame W is different from the origin of the end effector reference frame E. By solving the inverse kinematics model with reference to the wrist reference frame W instead of the end effector reference frame E, the position of the end effector 216 can be slightly varied from the goal position. When the operator 201 performs an operation without rotating the wrist 280, the offset between the end effector reference frame E and the wrist reference frame W is static, and relatively unnoticeable to the operator 201. However, as the joint angles of the wrist joints 268, 270 and 272 change, the offset between the wrist reference frame W and the end effector reference frame E can vary. Even when the wrist reference frame W is stationary, it is possible that the end effector reference frame E pitches up (FIG. 16a) or that the end effector reference frame E pitches down (FIG. 16b) so that the offset between the end effector reference frame E and the wrist reference frame W is no longer static.

To help address the offset between the end effector reference frame E and the wrist reference frame W, the controller processor 230 can perform an iteration of a Jacobian-based numerical inverse kinematics solver to enhance the alignment of the end effector 216 with the goal after aligning the wrist reference frame W with the goal reference frame G.

To define the Jacobian-based numerical inverse kinematics solver, a forward kinematics (F.K.) is defined to determine the position t_{R,E}^{F.K.}(q) of the end effector reference frame E:

$${T}_{R , E}^{F . K .} ( q ) = [ \begin{matrix}{R}_{R , E}^{F . K .} ( q ) & {t}_{R , E}^{F . K .} ( q ) \\ {0}_{1 \times 3} & 1\end{matrix} ] \qquad Eqn . ( 29 )$$

The desired velocity vector \dot{t} of the end effector 216 is set as the error between the goal position (t_{R,G}) and the forward kinematics position, as defined below:

\dot{t}=[t_{R,G}−t_{R,E}^{F.K.}(q),0,0,0]^{T}. Eqn. (30)

where the angular velocity terms are set to zero to avoid altering the rotation of the end effector reference frame E. The updated set of joint angles q⁺ is then obtained as follows:

q⁺=q+\dot{q} Eqn. (31)

where the offset joint angle, \dot{q}, is defined as \dot{q}=J(q)⁻¹\dot{t}.

In the embodiments described herein, the input to the control system 200 (or analogous systems) is a desired goal position of the end effector, as compared to the input being a desired velocity of the end effector and/or individual movement commands for each joint/degree of freedom in the robotic device. In contrast, some known control systems are configured to control the end effector by having the user input velocity or force-based commands as inputs to the system. This position-based approach may help facilitate greater accuracy in comparison with other control methods, such as controlling the velocity of an end effector directly and manual entry of a tool path. Manual entry, for example, can be tedious and time-consuming.

In some embodiments, the system can adapt the tool path, or its generated control signals to avoid collisions between the end effector 216 and external objects, and/or the end effector 216 with any other actuators mounted at the robotic device 210.

Once the set of joint angles q, or q⁺ when the Jacobian-based numerical inverse kinematics solver is used, is determined, the controller processor 130 can transmit the set of joint angles to the device processor 112 for operating each joint to the commanded angle.

At step 350 and 450, the controller processor 130 transmits command signals to the robotic device 210 to operate the end effector 216 according to the joint parameters determined at 340.

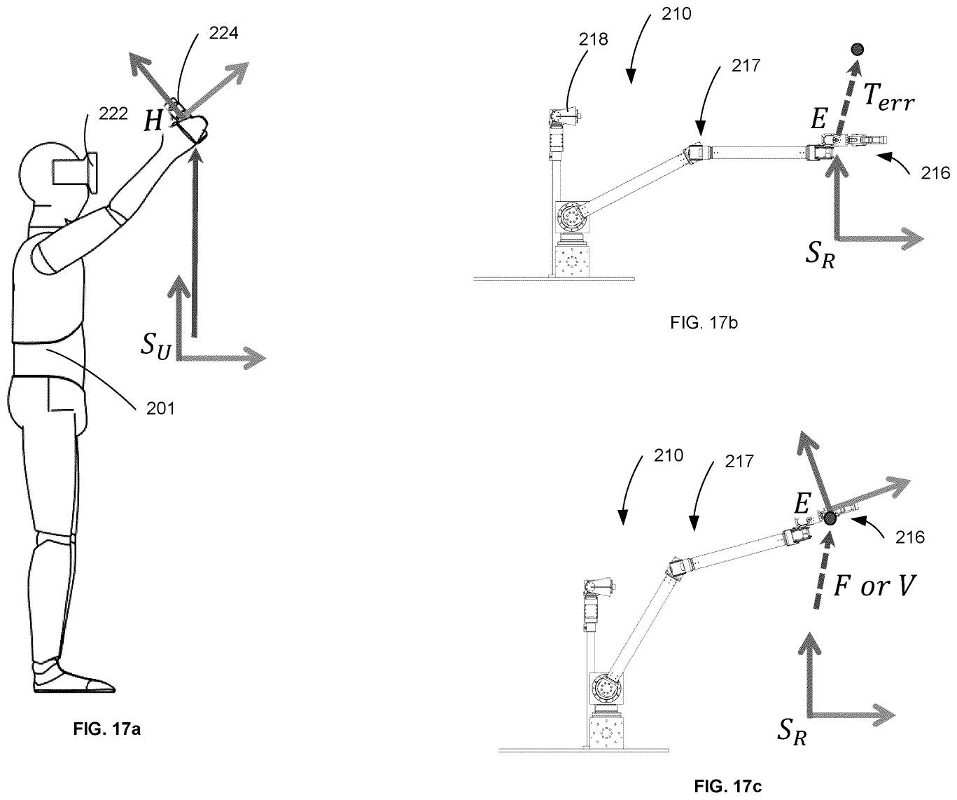

Optionally, instead of utilizing an inverse kinematics based control system, the robotic device may utilize an impedance or velocity based control method. For example, with reference to FIGS. 17a-17c, in such systems the force or velocity-based control signals are calculated based on the error between the goal frame G and the current end effector pose, frame E.

As described herein, when a user moves her hand (FIG. 17a) the pose of the goal frame G with respect to the robot reference frame can be solved as T_{R,G}. The current pose of the end effector (reference frame E) with respect to the robot reference frame can also be calculated as T_{R,E}. The system can then calculate the relative transformation between the goal frame G and the reference frame E which can be expressed as (FIG. 17b):

Tₑᵣᵣ=T_{R,G}⁻¹T_{R,E}

From this error, and its rate of change \dot{T}ₑᵣᵣ, the system can determine the velocity or force (FIG. 17c) that can be applied to the manipulator 217 as:

F=KₚTₑᵣᵣ+K_{D}\dot{T}ₑᵣᵣ for force-based calculations or,

V=KₚTₑᵣᵣ+K_{D}\dot{T}ₑᵣᵣ for velocity-based calculations.

The end effector force or velocity are then converted into joint torques or velocities, respectively, as appropriate for a given robotic device, and then executed accordingly.

In a force based controller, one way to convert the required force at the end effector to required joint torques is as follows:

τ=J^{T}(q)F

where J^{T}(q) is the transpose of the Jacobian matrix described earlier, and τ is a vector of torques that each joint needs to apply to achieve an end effector force F

When force control is used, it is also common to add torques required to compensate for the robot's inertia under acceleration, it's weight under gravity, joint friction, etc. These quantities can be obtained from equation 9a.

If Velocity Control is used, the vector desired joint velocities \dot{q} can be obtained as:

\dot{q}=J⁻¹(q)V

where J⁻¹(q) is the inverse of the Jacobian matrix described earlier.

Furthermore, these control methods are not limited to manipulators with a specific number of degrees of freedom. When the robot has more than 6 degrees of freedom, a secondary controller can be used to obtain some desirable configuration of the manipulator without affecting the pose of the end effector, for example by acting in the velocity or acceleration null-space of the primary velocity or force controllers described above.

When the manipulator has fewer than 6 degrees of freedom (but at least 1), the desired cartesian (output) degrees of freedom to be controlled can be selected, and control can be achieved in a reduced system.

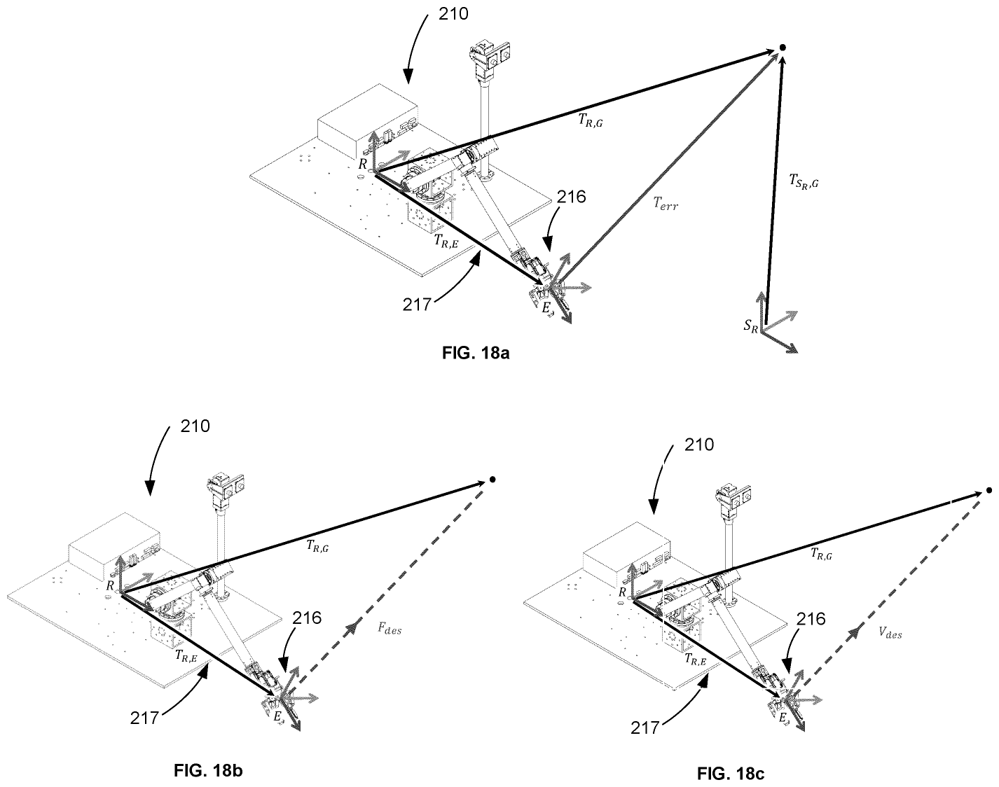

For further clarity, and referring also to FIGS. 18a-18c, in the present example and utilizing an impedance or velocity-based control method, the goal T_{S}_{_{R}}_{,G} is in the robot synchronization frame S_{R}. It is transformed into the robot frame R:

T_{R,G}=T_{R,S}_{_{R}}T_{S}_{_{R}}_{,G}

where T_{R,E} is known from forward kinematics and Tₑᵣᵣ is calculated: Tₑᵣᵣ=T_{R,G}⁻¹T_{R,E}. A desired force F_{des} (FIG. 18b) or desired velocity V_{des} (FIG. 18c) can then calculated proportional to Tₑᵣᵣ, and \dot{T}ₑᵣᵣ. The cartesian force and torque can be converted to joint torques, which are commanded to robot joints, and the cartesian linear and angular velocity can be converted to joint velocities which are commanded to the robot joints.

Referring to FIG. 19 another example of a robotic control system 300 includes a robotic device 310 and a user interface apparatus 320. The system 300 is analogous to system 100, and like features are shown using like reference characters indexed by 200.

In this example of the robotic device, the robotic device 310 includes a pair of remotely controllable manipulators 317a and 317b that are independently movable relative to each other, and each terminate with a respective end effector 316a and 316b respectively. The manipulators 317a and 317b are shown having different numbers of linkages (i.e. different configurations), but may be the same in other embodiments.

In this example, the user interface apparatus 320 includes two end effect controllers 324a and 324b, each associated with a respective end effector 316a and 316b. The end effect controller 324a may be associated with a user's left hand, while end effect controller 324b is associated with a user's right hand. The user may then utilize each of her hands when interacting with the robotic device 310, as if she were interacting with the environment around the robotic device 310. The movements of each end effect controller 324a and 324b may be individually tracked by the user interface apparatus 320 to allow a user to move the end effectors 316a and 316b separately. The control methods described herein can be performed independently and simultaneously for both end effect controllers 324a and 324b. Optionally, the system 300 could be configured to allow the user to control both end effectors 316a and 316b with a single end effector controller 324, or to control more than two end effectors and/or more than one robotic device by switching which controller 324 is associated with which end effectors and/or robotic device.

Preferably, each end effect controller 324a and 324b can be independently changed between engaged and disengaged modes. This may allow a user to disengage end effect controller 324a, for example to rest or re-position her left arm while keeping end effector 316a in a static position, while keeping end effect controller 342b engaged and continuing to control end effector 316b, or vice versa.

In this example, the system 300 includes a generally self-contained robot control module 390 that can be connected to an existing robotic device. The robot control module 390 can include the device processor 312, device storage component 313 and device interface component 314, and optionally can support the imaging component 318. The system 300 can be configured so that the device processor 312 and/or controller processor 330 can perform all of the required calculations and provide the control signals to the manipulators 317a, 317b and end effectors 316a and 316b. Alternatively, the robotic device 310 may include its own, device controller 392 that can control the rest of the device 310 in accordance with its desired control scheme. In such configurations, the robot control module 390 can be configured to communicate with, and provide command signals to the device controller 392, which can in turn execute the commands.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that the term “coupled” used herein indicates that two elements can be directly coupled to one another or coupled to one another through one or more intermediate elements.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the programmable computers may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Various embodiments have been described herein by way of example only. Various modification and variations may be made to these example embodiments without departing from the spirit and scope of the invention.

1. A control system for use with a robotic device having at least a first manipulator with at least a first end effector, the control system comprising:
a) a robot control module mountable to a robot having at least a first manipulator with at least a first end effector, the robot control module comprising;
an imaging component configured to capture images of an environment surrounding the robot through which the end effector is movable;
an output module that is communicably linked to the robot to control the movement of the first end effector;
b) a user interface apparatus that is remote from the robotic device and comprising:
a base station communicably linked to the robot control module to receive images of the environment surrounding the robot from the imaging component and to transmit movement instructions to the output module;
a display component communicably linked to the base station and configured to display the images of the environment surrounding the robot to a user; and
an end effector controller operable by the user to provide a goal position for the first end effector;
wherein the system is configured to:
assign a user synchronization frame to at a first controller position of the end effector controller at a first time;
assign a robot synchronization frame to the first end effector at a first end effector position;
track movement of the end effector controller to the goal position at a second time and to assign a hand frame;
generate a goal transformation based on the relative movement of the end effect controller from the first position to the goal position and the relative positions of the user synchronization frame and the hand frame;
express the goal transformation in the robot synchronization frame to define an end effector goal position, whereby robot control signals are generated and output from the robot control module to move the first end effector from the first robot position to the robot goal position.

2. The control system of claim 1, wherein the imaging component is configured to capture 3D images of the environment and the display component is a wearable VR display unit that provides 3D images to the user.

3. The control system of claim 1 or claim 2, wherein the imaging component comprises first and second cameras positioned adjacent each other.

4. The control system of any one of claims 1 to 3, wherein the imaging component has a field of view and is movable relative to the robot control module to move the field of view relative to the robot.

5. The control system of claim 4, wherein the imaging component is movable independently of the first end effector.

6. The control system of any one of claims 4 or 5, wherein the imaging component has a field of view and the first end effector is movable outside the field of view.

7. The control system of any one of claims 4 to 6, wherein the display apparatus comprises a display device that is wearable by the user, and wherein movement of the display device is tracked by the user interface apparatus and imaging command signals are generated based on the movement of the display device and are transmitted to the robot control module thereby causing corresponding movement of the imaging component.

8. The control system of claim 7, wherein the end effector controller is configurable in a disabled mode in which movements of the effector controller are tracked by the user interface apparatus and the movements of end effector controller are not transferred to the first end effector, and wherein movement of the display device causes corresponding movement of the imaging component when the first end effector controller is in the disable mode.

9. The control system of any one of claims 1 to 8, wherein the user interface module is remote from the robotic device.

10. The control system of any one of claims 1 to 9, wherein the user interface module is in wireless communication with the robot control module.

11. The control system of any one of claims 1 to 10, wherein the end effector controller is a hand-held apparatus that is movable by the user, and wherein movements of the end effector controller are translated into corresponding movements of the first end effector.

12. The control system of claim 11, wherein the position of the end effect controller is determined independently of a position/configuration of the user's arm.

13. The control system of any one of claims 1 to 12, wherein the robot control signals are generated using at least one of a force control, a velocity control and an inverse kinematics control scheme.

14. The control system of any one of claims 1 to 13, wherein
the first end effector controller is operable between a disabled mode and an enabled mode, wherein the movement tracked by the first end effector controller during the disabled mode causes no movement at the first end effector; and
the base station receives a disengagement signal from the first end effector controller to trigger the disabled mode and an engagement signal from the first end effector controller to resume the enabled mode.

15. A robotic control system comprising:
a) a robotic device having:
a base;
a manipulator mounted to the base, the manipulator having at least two degrees of freedom; and
an end effector operably coupled to the manipulator;
b) a user interface apparatus comprising:
a base station having a controller processor and being spaced from the robotic device and in communication with the robotic device via a communication network; and
an end effector controller spaced from the robotic device and configured to be manipulated by a user to define a goal for the end effector, the goal comprising a goal position;
wherein the system is selectably configurable in an engaged state in which the controller processor is configured to:
assign a robot synchronization reference frame to the end effector;
assign a user synchronization reference frame to the end effector controller;
operate the end effector controller to track a movement of the end effect controller from a first position to a goal position defined by an operator;
determine the goal based on the tracked movement with respect to at least the user synchronization reference frame;
generate a set of command signals for causing the end effector to move to the goal, the set of command signals generated with respect to at least the robot synchronization reference frame; and
and wherein the system is selectably configurable a disengaged state in which the controller processor is configured:
assign a user synchronization reference frame to the end effector controller;
operate the end effector controller to track a movement defined by an operator;
determine the goal based on the tracked movement with respect to at least the user synchronization reference frame but command signals for causing the end effector to move to the goal are not provided to the robotic device so that the end effector does not move in response to movements of the end effector controller.

16. A robotic control system comprising:
a robotic device having:
a base;
a manipulator mounted to the base, the manipulator having at least two degrees of freedom; and
an end effector operably coupled to the manipulator;
an end effector controller remote from the robotic device for defining a goal for the end effector, the goal comprising a goal position;
a controller processor in communication with the robotic device via a communication network and communicatively coupled to the end effector controller, the controller processor is operable to:
assign a robot synchronization reference frame to the end effector;
assign a user synchronization reference frame to the end effector controller;
operate the end effector controller to track a movement defined by an operator;
determine the goal based on the tracked movement with respect to at least the user synchronization reference frame; and
generate a set of robot command signals for causing the end effector to move to the goal, the set of robot command signals generated with respect to at least the robot synchronization reference frame.

17. The robotic control system of claim 16, wherein the goal comprises a goal orientation.

18. The robotic control system of any one of claims 16 and 17, wherein:
the end effector controller comprises a handheld component operable by the operator to define the movement, the handheld component having a hand reference frame; and
the controller processor assigns the user synchronization reference frame coincident to the hand reference frame.

19. The robotic control system of any one of claims 16 to 18, wherein:
the end effector has an end effector reference frame; and
the controller processor assigns the robot synchronization reference frame coincident to the effector reference frame.

20. The robotic control system of any one of claims 16 to 19, wherein:
the controller processor determines the goal based on the tracked movement in response to detecting a trigger event.

21. The robotic control system of claim 20, wherein the trigger event comprises at least one of a predefined time interval and the end effector controller being stationary for a defined time period.

22. The robotic control system of any one of claims 16 to 19, wherein:
the end effector controller is operable between a disabled mode and an enabled mode, the movement tracked by the end effector controller during the disabled mode causes no movement at the end effector; and
the controller processor receives a disengagement signal from the end effector controller to trigger the disabled mode and an engagement signal from the end effector controller to resume the enabled mode.

23. The robotic control system of claim 22, wherein the controller processor assigns the robot synchronization reference frame and the user synchronization reference frame in response to receiving the engagement signal.

24. The robotic control system of any one of claims 16 to 23, wherein the robotic device comprises an imaging component for collecting imaging data of a surrounding of the robotic device.

25. A robotic control system comprising:
an end effector controller for defining a goal for an end effector of a robotic device, the goal comprising a goal position; and
a controller processor in communication with the robotic device via a communication network and communicatively coupled to the end effector controller, the controller processor is operable to:
assign a robot synchronization reference frame to the end effector;
assign a user synchronization reference frame to the end effector controller;
operate the end effector controller to track a movement defined by an operator;
determine the goal based on the tracked movement with respect to at least the user synchronization reference frame; and
generate a set of robot command signals for causing the end effector to move to the goal, the set of robot command signals generated with respect to at least the robot synchronization reference frame.

26. The robotic control system of claim 25, wherein the goal comprises a goal orientation.

27. The robotic control system of any one of claims 25 and 26, wherein:
the end effector controller comprises a handheld component operable by the operator to define the movement, the handheld component having a hand reference frame; and
the controller processor assigns the user synchronization reference frame coincident to the hand reference frame.

28. The robotic control system of any one of claims 25 to 27, wherein:
the end effector has an end effector reference frame; and
the controller processor assigns the robot synchronization reference frame coincident to the effector reference frame.

29. The robotic control system of any one of claims 25 to 28, wherein:
the controller processor determines the goal based on the tracked movement in response to detecting a trigger event.

30. The robotic control system of claim 29, wherein the trigger event comprises at least one of a predefined time interval and the end effector controller being stationary for a defined time period.

31. The robotic control system of any one of claims 25 to 28, wherein:
the end effector controller is operable between a disabled mode and an enabled mode, the movement tracked by the end effector controller during the disabled mode causes no movement at the end effector; and
the controller processor receives a disengagement signal from the end effector controller to trigger the disabled mode and an engagement signal from the end effector controller to resume the enabled mode.

32. The robotic control system of claim 31, wherein the controller processor assigns the robot synchronization reference frame and the user synchronization reference frame in response to receiving the engagement signal.

33. A method for remotely controlling a robotic device, the method comprising operating a controller processor in communication with the robotic device via a communication network and communicatively coupled to an end effector controller to:
assign a robot synchronization reference frame to an end effector of the robotic device;
assign a user synchronization reference frame to the end effector controller;
operate the end effector controller to track a movement defined by an operator;
determine the goal based on the tracked movement with respect to at least the user synchronization reference frame; and
generate a set of command signals for causing the end effector to move to the goal, the set of command signals generated with respect to at least the robot synchronization reference frame.

34. The method of claim 33, wherein the goal comprises a goal orientation.

35. The method of any one of claims 33 and 34, wherein:
the end effector controller comprises a handheld component operable by the operator to define the movement, the handheld component having a hand reference frame; and
the controller processor is operated to assign the user synchronization reference frame coincident to the hand reference frame.

36. The method of any one of claims 33 to 35, wherein:
the end effector has an effector reference frame; and
the controller processor is operated to assign the robot synchronization reference frame coincident to the effector reference frame.

37. The method of any one of claims 33 to 36, wherein the controller processor is operated to:
detect a trigger event; and
determine the goal based on the tracked movement in response to the detected trigger event.

38. The method of claim 37, wherein the trigger event comprises at least one of a predefined time interval and the end effector controller being stationary for a defined time period.

39. The method of any one of claims 33 to 36, wherein the controller processor:
receives a disengagement signal from the end effector controller to trigger a disabled mode, the movement tracked by the end effector controller during the disabled mode causes no movement at the end effector; and
receives an engagement signal from the end effector controller to resume an enabled mode at the end effector controller.

40. The method of claim 39, wherein the controller processor, in response to receiving the engagement signal, assigns the robot synchronization reference frame and the user synchronization reference frame.
